(19) United States
(12) Patent Application Publication
(10) Pub. No.: US 2026/0214278 A1
(43) Pub. Date: Jul. 23, 2026

(54) POINT CLOUD PROCESSING METHOD AND APPARATUS, STORAGE MEDIUM, AND ELECTRONIC DEVICE

(71) Applicant: TENCENT TECHNOLOGY (SHENZHEN) COMPANY LIMITED, Shenzhen (CN)

(72) Inventors: Wenjie ZHU, Shenzhen (CN); Xiaozhong XU, Shenzhen (CN)

(21) Appl. No.: 19/572,620

(22) Filed: Mar. 19, 2026

Related U.S. Application Data
(63) Continuation of application No. PCT/CN2024/109311, filed on Aug. 1, 2024.

(30) Foreign Application Priority Data
Sep. 21, 2023 (CN) 202311234799.6

(51) Int. Cl. H04N 19/70; H04N 19/119; H04N 19/124; H04N 19/136; H04N 19/172; H04N 19/174; H04N 19/186

(52) U.S. Cl. CPC H04N 19/70; H04N 19/119; H04N 19/124; H04N 19/136; H04N 19/172; H04N 19/174; H04N 19/186

(57) ABSTRACT

A point cloud processing method includes: obtaining decoding indication information of a point cloud bit-stream, the decoding indication information including at least one of a first indication parameter or a second indication parameter, the first indication parameter being set in sequence-level parameter information of a point cloud sequence and providing sequence-level decoding indication, the second indication parameter being set in frame-level or slice-level parameter information of the point cloud sequence and providing frame-level or slice-level decoding indication; and decoding the point cloud bit-stream according to the first indication parameter or the second indication parameter.

### CROSS-REFERENCES TO RELATED APPLICATIONS

This application is a continuation of PCT Application No. PCT/CN2024/109311, filed on Aug. 1, 2024, which claims priority to Chinese Patent Application No. 2023112347996, filed with the China National Intellectual Property Administration on Sep. 21, 2023 and entitled “POINT CLOUD PROCESSING METHOD AND APPARATUS, STORAGE MEDIUM, AND ELECTRONIC DEVICE”, the entire contents of all of which are incorporated herein by reference.

### FIELD OF THE TECHNOLOGY

The present disclosure relates to the field of image encoding and decoding technologies, and in particular, to a point cloud processing method and apparatus, a storage medium, and an electronic device.

### BACKGROUND OF THE DISCLOSURE

A point cloud is a set of points obtained by performing data acquisition on a surface of an object by using a measurement instrument. The point cloud is widely applied to various fields such as autonomous driving, high-definition maps, and virtual reality. However, because the point cloud usually includes tens of thousands of points to hundreds of millions of three-dimensional points, a severe challenge is brought to data storage, processing, transmission, and display. Currently, storage resources and transmission bandwidths are unbearable to the point cloud. Therefore, it is necessary to encode and compress the point cloud to obtain a point cloud bit-stream, and replace the point cloud with the point cloud bit-stream for storage or transmission.

Currently, a common point cloud encoding and compressing method includes geometry-based point cloud compression (GPCC). During point cloud compression, a sequence header is generally utilized to perform decoding indication on a parameter varying frame by frame. Indication information corresponding to each point cloud frame is defined in the sequence header. When each point cloud frame is decoded, the sequence header is parsed to obtain the corresponding indication information, resulting in low decoding efficiency.

### SUMMARY

The present disclosure aims to solve at least one of technical problems existing in related art. Therefore, the present disclosure provides a point cloud processing method and apparatus, a storage medium, and an electronic device, to improve point cloud decoding efficiency.

According to a first aspect, the present disclosure provides a point cloud processing method, applied to a decoding device, and including: obtaining decoding indication information of a point cloud bit-stream, the decoding indication information including at least one of a first indication parameter or a second indication parameter, the first indication parameter being set in sequence-level parameter information of a point cloud sequence, the second indication parameter being set in frame-level or slice-level parameter information of the point cloud sequence, the first indication parameter providing sequence-level decoding indication, and the second indication parameter providing frame-level or slice-level decoding indication; and decoding the point cloud bit-stream according to the first indication parameter or the second indication parameter. In some embodiments, decoding indication is performed uniformly on each point cloud frame in the entire point cloud sequence by using the sequence-level first indication parameter, and when decoding is performed according to the frame-level or slice-level second indication parameter, the second indication parameter can be obtained quickly when the point cloud frame or a point cloud slice is parsed, so that the decoding efficiency is relatively high.

According to a second aspect, the present disclosure provides a point cloud processing method, applied to an encoding device, and including: obtaining point cloud data; encoding and compressing the point cloud data, to obtain a point cloud bit-stream, decoding indication information of the point cloud bit-stream including at least one of a first indication parameter or a second indication parameter, the first indication parameter being set in sequence-level parameter information of a point cloud sequence, the second indication parameter being set in frame-level or slice-level parameter information of the point cloud sequence, the first indication parameter providing sequence-level decoding indication, the second indication parameter providing frame-level or slice-level decoding indication, and the point cloud bit-stream being decoded according to the first indication parameter or the second indication parameter.

According to a third aspect, the present disclosure provides a point cloud processing apparatus, applied to a decoding device, and including a first obtaining module and a decoding module. The first obtaining module is configured to obtain decoding indication information of a point cloud bit-stream, the decoding indication information including at least one of a first indication parameter or a second indication parameter, the first indication parameter being set in sequence-level parameter information of a point cloud sequence, the second indication parameter being set in frame-level or slice-level parameter information of the point cloud sequence, the first indication parameter providing sequence-level decoding indication, and the second indication parameter providing frame-level or slice-level decoding indication; and the decoding module is configured to decode the point cloud bit-stream according to the first indication parameter or the second indication parameter.

According to a fourth aspect, the present disclosure provides a non-transitory computer-readable storage medium, having a computer program stored therein, the computer program, when executed by a processor, implementing any one of the aforementioned point cloud processing methods.

According to a fifth aspect, the present disclosure provides an electronic device, including a memory, a processor, and a computer program stored in the memory and executable on the processor, the processor, when executing the program, implementing any one of the aforementioned point cloud processing methods.

According to the point cloud processing method and apparatus, the storage medium, and the electronic device provided in the embodiments of the present disclosure, the decoding indication information of the point cloud bit-stream is obtained, the sequence-level first indication parameter and the frame-level or slice-level second indication parameter are defined in the decoding indication information, the first indication parameter is set in the sequence-level parameter information of the point cloud sequence, and the second indication parameter is set in the frame-level or slice-level parameter information of the point cloud sequence, and then the decoding is performed according to the first indication parameter or the second indication parameter. When decoding is performed according to the sequence-level first indication parameter, each point cloud frame of the point cloud sequence is decoded by using a unified first indication parameter without parsing an indication parameter corresponding to each point cloud frame, so that the decoding efficiency is relatively high. When the decoding is performed according to the frame-level or slice-level second indication parameter, the frame-level or slice-level decoding may be implemented according to the second indication parameter, so that each point cloud frame or each point cloud slice has the adaptive second indication parameter, and frame-by-frame or slice-by-slice variation of the second indication parameter is achieved. Compared with a method where the sequence header needs to be parsed to obtain the indication parameter corresponding to the point cloud frame when the point cloud frame is parsed each time for decoding, resulting in relatively low decoding efficiency, the sequence header does not need to be parsed to obtain the indication parameter for each point cloud frame, and the corresponding second indication parameter may be obtained rapidly, so that the decoding efficiency is relatively high.

### BRIEF DESCRIPTION OF THE DRAWINGS

The foregoing and/or additional aspects and advantages of the present disclosure become apparent and easily understood from the description of the embodiments with reference to the following accompanying drawings.

FIG. 1a is a schematic diagram of three degrees of freedom (3DoF) according to an embodiment of the present disclosure.

FIG. 1b is a schematic diagram of three degrees of freedom plus (3DoF+) according to an embodiment of the present disclosure.

FIG. 1c is a schematic diagram of six degrees of freedom plus (6DoF+) according to an embodiment of the present disclosure.

FIG. 2 is a schematic diagram of a framework of a point cloud processing system of point cloud media according to an embodiment of the present disclosure.

FIG. 3 is a schematic diagram of a point cloud encoding framework according to an embodiment of the present disclosure.

FIG. 4 is a schematic flowchart of a point cloud processing method according to an embodiment of the present disclosure.

FIG. 5 is a schematic flowchart of a point cloud processing method according to an embodiment of the present disclosure.

FIG. 6 is a schematic flowchart of a point cloud processing method according to an embodiment of the present disclosure.

FIG. 7 is a schematic flowchart of another point cloud processing method according to an embodiment of the present disclosure.

FIG. 8 is a schematic structural diagram of a point cloud processing apparatus according to an embodiment of the present disclosure.

FIG. 9 is a schematic structural diagram of another point cloud processing apparatus according to an embodiment of the present disclosure.

FIG. 10 is a schematic structural diagram of an electronic device according to an embodiment of the present disclosure.

FIG. 11 is a schematic diagram of a hardware structure of an electronic device according to an embodiment of the present disclosure.

### DESCRIPTION OF EMBODIMENTS

Embodiments of the present disclosure are described below in detail. Examples of the embodiments are shown in the accompanying drawings, where same or similar reference numerals denote the same or similar elements or elements having the same or similar functions. The embodiments described below with reference to the accompanying drawings are exemplary, and are merely used to explain the present disclosure, but cannot be understood as limitations to the present disclosure.

Some technical terms in the present disclosure are described below.

### I. Point Cloud

The point cloud is a set of discrete points that are irregularly distributed in a space and express a spatial structure and a surface attribute of a three-dimensional object or scene. Each point in the point cloud includes at least geometric data, and the geometric data is configured for representing three-dimensional position information of the point. According to different application scenes, the points in the point cloud may further include one or more groups of attribute data. Each group of attribute data is configured for reflecting an attribute of the point. The attribute may be, for example, a color, a material, or other information. Generally, each point in the point cloud has the same number of groups of attribute data.

The point cloud may flexibly and conveniently express the spatial structure and surface attribute of the three-dimensional object or scene, and therefore is widely applied to the scenes including a virtual reality (VR) game, a computer aided design (CAD), a geographic information system (GIS), an autonomous navigation system (ANS), a digital cultural heritage, free viewpoint broadcasting, three-dimensional immersive telepresence, three-dimensional reconstruction of biological tissues and organs, and the like.

The point cloud is mainly obtained in the following ways: computer generation, three-dimensional (3D) laser scanning, 3D photogrammetry, and the like. Specifically, the point cloud may be obtained by acquiring a visual scene of a real world using an acquisition device (a group of cameras or a camera device with a plurality of lenses and sensors), the point cloud of a static real-world three-dimensional object or scene may be obtained by means of 3D laser scanning, and millions of point clouds may be obtained every second; the point cloud of a dynamic real-world three-dimensional object or scene may be obtained by 3D photographing, and tens of millions of point clouds may be obtained every second; and furthermore, in the medical field, the point cloud of biological tissues and organs may be obtained through magnetic resonance imaging (MRI), computed tomography (CT), and electromagnetic positioning information. For another example, the point cloud may alternatively be directly generated by a computer according to a virtual three-dimensional object and scene. For example, the computer may generate a point cloud of a virtual three-dimensional object and scene. With continuous accumulation of large-scale point cloud data, efficient storage, transmission, publication, sharing, and standardization of the point cloud data are crucial to the application of the point cloud.

### II. Point Cloud Media

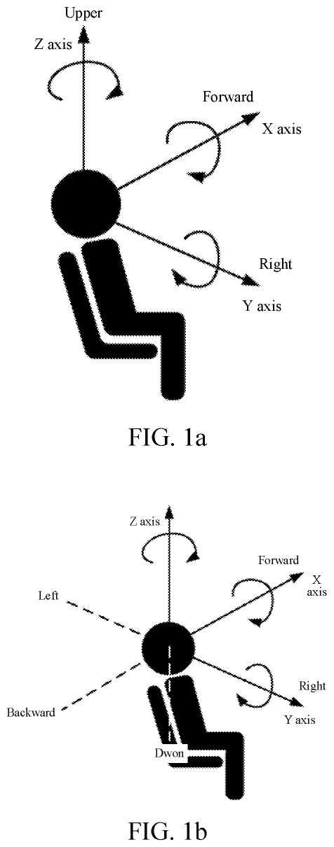

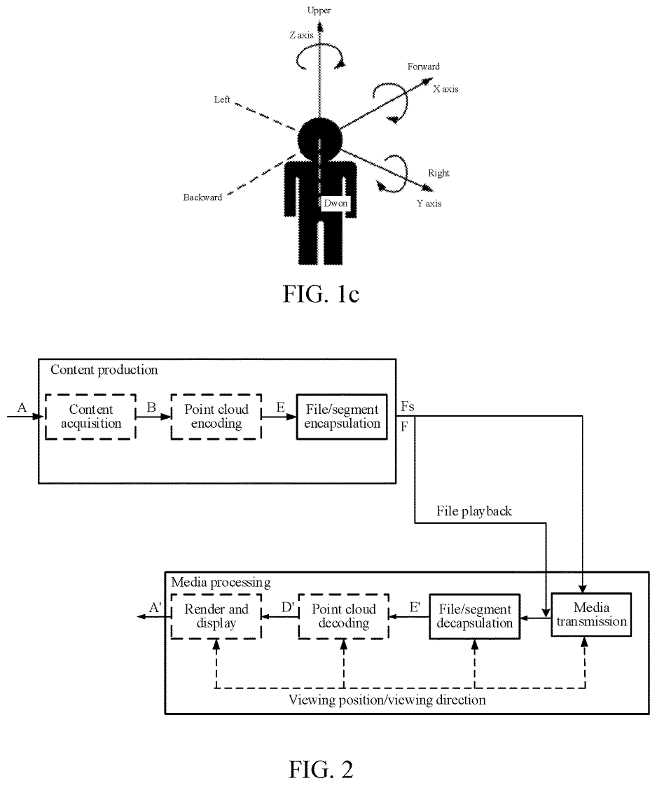

The point cloud media is typical six degrees of freedom (6DoF) immersive media. The immersive media is a media file that can provide immersive media content to enable a viewer immersed in the media content to obtain visual, auditory, and other sensory experiences in the real world. The immersive media may be divided into six degrees of freedom (6DoF) immersive media, three degrees of freedom (3DoF) immersive media, and three degrees of freedom plus (3DoF+) immersive media according to a degree of freedom of the viewer when consuming the media content. FIG. 1a is a schematic diagram of three degrees of freedom (3DoF) according to an embodiment of the present disclosure. 3DoF refers to three degrees of freedom, in which the viewer of the immersive media is fixed at a center point of a three-dimensional space, and a head of the viewer of the immersive media turns along an X axis, a Y axis, and a Z axis, to observe visuals provided by media content. FIG. 1b is a schematic diagram of three degrees of freedom plus (3DoF+) according to an embodiment of the present disclosure. 3DoF+ refers to three degrees of freedom plus a limited movement degree of the head of the viewer of the immersive media along the X axis, the Y axis, and the Z axis. FIG. 1c is a schematic diagram of six degrees of freedom (6DoF) according to an embodiment of the present disclosure. 6DoF refers to three degrees of freedom plus unrestricted movement degree of the head of the viewer of the immersive media along the X axis, the Y axis, and the Z axis.

The point cloud processing method provided in the embodiment of the present disclosure may be applied to a point cloud processing system for the point cloud media. The point cloud processing system may include a content producing device (corresponding to an encoding device) and a content presentation device (corresponding to a decoding device). The content producing device may be a computer device used by a provider of the point cloud media (such as a content maker of the point cloud media). The computer device may be a terminal (such as a personal computer (PC) or an intelligent mobile device (such as a smartphone)) or a server. The server may be an independent physical server, a server cluster or a distributed system including a plurality of physical servers, or a cloud server providing basic cloud computing services such as a cloud service, a cloud database, cloud computing, a cloud function, cloud storage, a network service, cloud communication, a middle-ware service, a domain name service, a security service, a CDN, and a big data and artificial intelligence platform. The content presentation device may refer to a computer device used by a user of the point cloud media (such as a viewer of the point cloud media, i.e., a service object). The computer device may be a terminal (such as a personal computer (PC), an intelligent mobile device (such as a smartphone), a VR device (such as a VR helmet and VR glasses), a smart appliance, an in-vehicle terminal, or an aircraft). A client is integrated into the computer device. The client herein may be a client having a function of displaying data information such as text, an image, an audio, and a video, and includes, but is not limited to, a multimedia client (such as a video client), a social client (such as an instant messaging client), an information application (such as a news client), an entertainment client (such as a game client), a shopping client, an in-vehicle client, a browser, and the like. The client may be an independent client, or may be an embedded sub-client integrated in a client (such as a social client). This is not limited herein.

The content producing device and the content presentation device may be a same device, or may be different devices, and both include multiple modules. The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Different modules are configured to implement different functions. These modules may be integrated in a same electronic device, or may be located in different electronic devices. The content producing device may be configured to implement functions such as acquisition, encoding, and encapsulation of the point cloud media. Correspondingly, the content presentation device may be configured to implement functions such as decapsulation, decoding, rendering, and display of an encapsulated file. FIG. 2 is a schematic diagram of a data processing framework of a point cloud processing system of point cloud media according to an embodiment of the present disclosure.

In FIG. 2, at a content producing device side, a real-world visual scene A is captured and acquired by a group of cameras or a camera device having a plurality of lenses and sensors, an acquisition result is point cloud media B, and the point cloud media B is a frame sequence including a large number of point cloud frames. One or more point cloud frames are encoded into a point cloud bit-stream E, including encoded geometric bit-streams and attribute bit-streams. Then, encapsulation processing is performed on the point cloud bit-stream E according to a specific media container file format (such as ISOBMFF), to obtain a sequence (Fs) of initialization segments and media segments for streaming transmission or a media file (F) for file playback. In an encapsulation process, meta-data is further included into the file F or the media segment Fs, and then the segment Fs may be transmitted to the content presentation device by using a transmission mechanism. The transmission mechanism may include, but is not limited to, a DASH protocol, an HLS protocol, an SMTP protocol, a TCP protocol, and the like.

At the content presentation device side, the sequence (Fs) or the media file (F) is decapsulated to obtain a point cloud bit-stream E′, meta-data is parsed, then the point cloud bit-stream E′ is decoded to generate point cloud media D′, then the point cloud media D′ is rendered, and a corresponding visual scene A′ is presented. In a data processing process at the content presentation device side, the decoded point cloud media D′ may be rendered and displayed on a screen of a head-mounted display or any other display device according to a viewing position or a viewing direction of a current viewer or a window determined by various types of sensors (such as a head, position, or eye sensing sensor). Partially accessing the decoded point cloud media by using the current viewing position or the viewing direction may be configured for optimizing a processing process of the point cloud media.

A point cloud processing technology involved in the present disclosure (mainly including an encoding technology and a decoding technology) may be implemented by using a cloud technology. For example, a cloud server serves as the content producing device. The cloud technology refers to a hosting technology that unifies a series of resources such as hardware, software, and a network in a wide area network or a local area network, to implement data computing, storage, processing, and sharing.

III. Point cloud data. Geometric information and attribute information of each point in the point cloud jointly form point cloud data. The geometric information may further be referred to as three-dimensional position information. The geometric information of a point in the point cloud refers to spatial coordinates (x, y, z) of the point, and may include coordinate values of the point in directions of coordinate axes of a three-dimensional coordinate system, such as a coordinate value x in a direction of the x axis, a coordinate value y in a direction of the y axis, and a coordinate value z in a direction of the z axis. The attribute information of a point in the point cloud may include at least one of the following: color information, material information, and laser reflection intensity information (which may also be referred to as reflectivity). Generally, each point in the point cloud has a same amount of attribute information. For example, each point in the point cloud may have two kinds of attribute information, namely, the color information and the laser reflection intensity. For another example, each point in the point cloud may have three kinds of attribute information, namely, the color information, the material information, and the laser reflection intensity information.

IV. Point cloud compression (PCC). Point cloud encoding refers to a process of encoding the geometric information and attribute information of each point in the point cloud to obtain a compressed bit-stream (which may further be referred to as a point cloud bit-stream). The point cloud encoding may include a geometric information encoding process and an attribute information encoding process. Currently, mainstream point cloud encoding technologies may be classified into geometry-based point cloud encoding and projection-based point cloud encoding for different types of point cloud. Herein, geometry-based point cloud compression (G-PCC) in a moving picture expert group (MPEG), and a point cloud encoding standard AVS-PCC in an audio video encoding standard (AVS) are taken as an example for description.

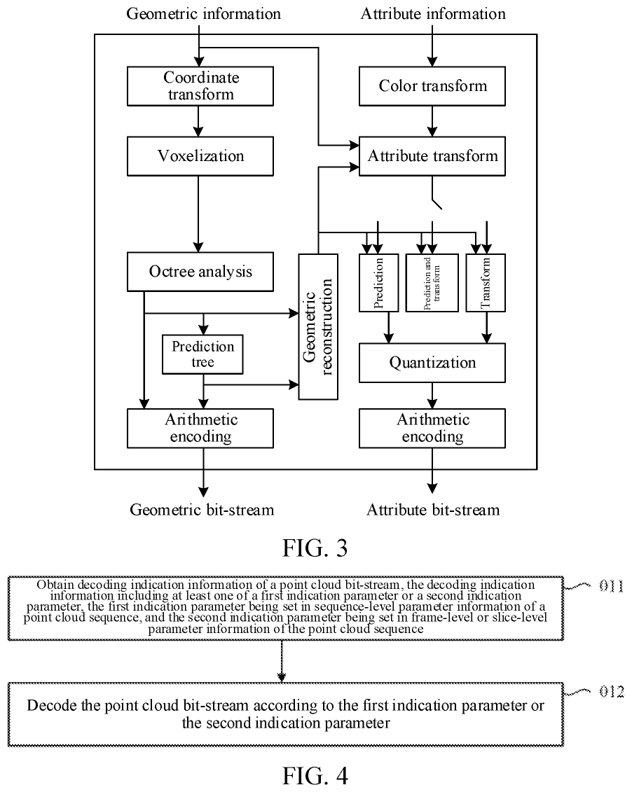

Encoding frameworks of the G-PCC and the AVS-PCC are approximately the same. Using the G-PCC as an example, FIG. 3 shows an encoding framework of the GPCC, which may be divided into a geometric information encoding process and an attribute information encoding process. In the geometric information encoding process, the geometric information of each point in the point cloud is encoded, to obtain a geometric bit-stream; in the attribute information encoding process, the attribute information of each point in the point cloud is encoded, to obtain an attribute bit-stream; and the geometric bit-stream and the attribute bit-stream jointly form a compressed bit-stream of the point cloud.

For the geometric information encoding process, main operations and processing may be described as follows.

(1) Pre-processing may include coordinate transform and voxelization. Through operations of scaling and translating, point cloud data in a three-dimensional space is converted into an integer form, and a minimum geometric position of the point cloud data is moved to a coordinate origin.

(2) Geometric encoding may include two modes, i.e., octree-based geometric encoding and trisoup-based geometric encoding, and the two encoding modes may be used under different conditions.

To be specific,

for the octree-based geometric encoding, octree is a tree-shaped data structure. During partition of the three-dimensional space, a preset bounding box is evenly partitioned, and each node has eight child nodes. Whether occupancy is performed on each child node of the octree is indicated by using ‘1’ and ‘0’, to obtain an occupancy code as the bit-stream of point cloud geometric information.

For the trisoup-based geometric encoding, the point cloud is partitioned into blocks of a specific size, an intersection of a surface of the point cloud with an edge of the block is positioned, and a triangle is constructed. The geometric information is compressed by encoding the intersection position.

(3) Geometry quantization: quantization fineness is usually determined by a quantization parameter (QP). A larger value of the QP indicates that coefficients within a larger value range are quantized to a same output. Therefore, larger distortion and a lower bit rate are usually caused. On the contrary, the smaller value of the QP indicates that the coefficients within a smaller value range are quantized to the same output. Therefore, smaller distortion and a corresponding higher bit rate may be caused.

(4) Geometry entropy encoding: statistical compression encoding is performed on occupancy code information of the octree, and a binary (0 or 1) compressed bit-stream is finally outputted. The statistical encoding is a lossless encoding mode, which can effectively reduce a bit rate required to express a same signal. A commonly used statistical encoding mode is content adaptive binary arithmetic encoding (CABAC).

For the attribute information encoding process, main operations and processing may be described as follows.

(1) Attribute recoloring: in a case of lossy encoding, after the geometric coordinate information is encoded, the geometric information needs to be decoded and reconstructed by an encoding end. To be specific, geometric information of each point of the point cloud is recovered. Attribute information corresponding to one or more neighbor points is searched for in an original point cloud to serve as the attribute information of a reconstructed point.

(2) Attribute information processing: the attribute information processing may include three attribute encoding modes, namely, attribute prediction, attribute transform, and attribute prediction and transform. The three attribute encoding modes may be used under different conditions.

To be specific,

attribute prediction: It includes determining a neighbor prediction point of a to-be-encoded point from the encoded points based on information such as a distance or a spatial relationship, and calculating attribute prediction information of the to-be-encoded point based on a set criterion and according to attribute information of the neighbor prediction point. A difference between real attribute information and the predicted attribute information of the to-be-encoded point is calculated and serves as attribute residual information, and quantization and entropy encoding are performed on the attribute residual information.

Attribute transform: It includes grouping and transforming the attribute information by using transform methods such as discrete cosine transform (DCT) and Haar transform (Haar), to obtain a transform coefficient, and performing quantization and entropy encoding on the transform coefficient.

Attribute prediction and transform: preceding operations are the same as those in the attribute prediction. After the attribute residual information of the to-be-encoded point is obtained, the attribute residual information of the to-be-encoded point is transformed by using a transform algorithm to obtain the transform coefficient, and then quantization and entropy encoding are performed on the transform coefficient.

Before the attribute prediction and transform, the geometric decoding points need to be grouped. A grouping process is described below by using color attributes and reflectivity attributes respectively.

For the color attribute, geometric points of the resorted point cloud are grouped sequentially, and an initial right-shift number L_{base} is obtained through calculation. According to L_{base}, a current right-shift number is obtained, grouping is performed according to the current right-shift number, a maximum transform order number is set to colorMaxTransNum, and a specific grouping rule is as follows.

a. A calculation formula of an initial right-shift number L_{base} is as follows:

$${L}_{b a s e} = max ( 3 , round ( 3 * ( {log}_{2} ( maxSize ) - \frac{{log}_{2} ( \frac{N}{{K}_{m e a n}} )}{2} ) ) )$$

b. Points with identical Hilbert codes after being right-shifted by L bits are grouped together. If the number of points in a current block is less than or equal to the maximum transform order number colorMaxTransNum, the points are determined to be in a group. If the number of the points in the current block is greater than colorMaxTransNum, the points in the block are further sub-grouped according to the following rules:

During the subgrouping process, the current right-shift number L is obtained, the right-shift number for the current sub-grouping is L₁=L−1, and the points with identical Hilbert codes after being right-shifted by L₁ are then grouped into a new sub-group. Whether the number of points in the newly formed sub-group is greater than colorMaxTransNum continues to be determined, if the number of the points is greater than colorMaxTransNum, the sub-grouping operation repeats iteratively until the number of the points in all sub-groups is less than or equal to colorMaxTransNum.

c. L is dynamically adjusted at the same time according to a specific rule as follows: an average value B of the number of geometric points in eight consecutive groups is statistically collected; if the value of B is less than 2, L=L+1; if the value of B is greater than 8, L=L−1; and otherwise, L is unchanged. L is an integer greater than or equal to 3, and the value of L is adjusted for every 32 groups.

d. Whether the point is a duplicate point of the previously grouped point is determined, and if the duplicate point is found, the duplicate point is employed to supplement a current group up to colorMaxTransNum points. Subsequent duplicate points are sequentially grouped in sets of colorMaxTransNum, and the remaining points automatically form a group.

For the reflectivity attribute, the resorted geometric points are sequentially grouped, an initial right-shift number is obtained through calculation, a current right-shift number is obtained, grouping is performed according to the current right-shift number, and a maximum transform order number is set to refMaxTransNum. A specific grouping rule is as follows:

a. When refMaxTransNum is not equal to 4, the initial right-shift number L_{base}=3; and when refMaxTransNum is equal to 4, a calculation formula of the initial right-shift number L_{base} is as follows:

$${L}_{b a s e} = max ( 3 , 3 * ( \frac{max B i t s - min B i t s}{3} ) ) + shift$$

where a maximum number maxBits of bits is a base-2 logarithm log₂ of a volume of a point cloud bounding box:

$$maxBits = {log}_{2} ( x y z )$$

a minimum number minBits of bits is a base-2 logarithm log₂ of a number voxelCount of points in the point cloud:

$$minBits = {log}_{2} ( voxelCount )$$

an initial offset shift is determined by determining a value of attrQuantParam in sps, if attrQuantParam is greater than or equal to 32, shift is equal to 12, and otherwise, shift is equal to −6:

$$shift = ( sps . attrQuantParam >= 32 ) ? 2 : \text{-} 6$$

b. The points with identical Hilbert codes after being right-shifted by L_{base} bits are grouped into a same macro-block. The points in each macro-block are grouped, and if a current point is a duplicate point, the duplicate point is employed to supplement the group up to refMaxTransNum points.

If the number Kⱼ of points in a j^{th} block is greater than refMaxTransNum, the j^{th} block is further grouped by using the following method: refMaxTransNum points are sequentially taken until the number of points in each group in the block is less than or equal to refMaxTransNum.

c. When refMaxTransNum is greater than 2, the right-shift number L is dynamically adjusted.

An initial value of L is set to L_{base}; a total number of geometric points in previous N groups (N=8) is statistically collected, an average number of points in the N groups is calculated, and if the average number of the points is less than 2, L=L+1; if the average number of the points is greater than refMaxTransNum, L=L−1; and otherwise, L is unchanged. L is an integer greater than or equal to 1, and the value of L is adjusted for every 8 groups.

(3) Attribute information quantization: the quantization fineness is usually determined by a quantization parameter. The transform coefficient and/or attribute residual information obtained by processing the attribute information is quantized, and entropy encoding is performed on a quantization result. For example, during attribute prediction, the entropy encoding is performed on the quantized attribute residual information. During attribute transform and attribute prediction and transform, the entropy encoding is performed on the quantized transform coefficient.

(4) Attribute entropy encoding: the quantized attribute residual information and/or transform coefficient is usually finally compressed by using entropy encoding method such as run length encoding and arithmetic encoding. Corresponding information such as an attribute encoding mode and the quantization parameter is further encoded by using an entropy encoder.

V. Point cloud decoding. The point cloud decoding refers to a process of decoding a compressed bit-stream obtained by encoding a point cloud, to reconstruct the point cloud. Specifically, decoding the point cloud bit-stream mainly relates to two portions of content: decoding the geometric bit-stream (namely, target geometric data) of the point cloud media, and decoding the attribute bit-stream (namely, the target attribute data) of the point cloud media. The decoding process and the encoding and compressing process of the point cloud bit-stream are reversible. After decoding the point cloud bit-stream, the content presentation device may further render and display decoded data, to present the point cloud media to the user (refer to FIG. 2).

The decoding process of the point cloud in an attribute prediction mode and an attribute prediction and transform mode is described in detail herein.

In the attribute prediction mode, entropy decoding may be performed on the attribute bit-stream, to obtain quantized attribute residual information of a to-be-decoded point, and inverse quantization is performed on the quantized attribute residual information, to obtain the attribute residual information of the to-be-decoded point; a neighbor prediction point of the to-be-decoded point is determined from the decoded points according to the information such as a distance or a spatial relationship, and the attribute prediction information of the to-be-decoded point is calculated based on a set criterion and according to attribute reconstruction information of the neighbor prediction point; and then, the attribute information (which may be referred to as the attribute reconstruction information) of the to-be-decoded point may be reconstructed according to the attribute residual information of the to-be-decoded point and the attribute prediction information of the to-be-decoded point.

In the attribute prediction and transform mode, the entropy decoding may be performed on the attribute bit-stream, to obtain a quantized transform coefficient of the to-be-decoded point, the inverse quantization is performed on the quantized transform coefficient to obtain a transform coefficient, and the inverse transform is performed on the transform coefficient to obtain the attribute residual information of the to-be-decoded point; and a neighbor prediction point of the to-be-decoded point is determined from the decoded points according to the information such as a distance or a spatial relationship, and the attribute prediction information of the to-be-decoded point is calculated based on a set criterion and according to attribute reconstruction information of the neighbor prediction point; and then, the attribute information (which may be referred to as the attribute reconstruction information) of the to-be-decoded point may be re-constructed according to the attribute residual information of the to-be-decoded point and the attribute prediction information of the to-be-decoded point.

Based on the introduction about the basic concepts, an embodiment of the present disclosure provides a point cloud processing method and apparatus, a storage medium, and an electronic device.

To support the point cloud processing method in the embodiments of the present disclosure, in the embodiments of the present disclosure, based on the related art, a plurality of descriptive fields are added at a system level to define a corresponding high-level syntactic data structure. In the following content, the foregoing point cloud processing method is described in detail with reference to various syntactic tables.

In the embodiments of the present disclosure, a point cloud sequence includes a start code, the start code is a group of specific bit strings, and corresponding content of each portion in the point cloud sequence may be extracted by using the start code. In a point cloud bit-stream conforming to the embodiments of the present disclosure, none of these bit strings occurs in any case except the start code.

The start code includes a start code prefix and a start code value. The start code prefix is a bit string ‘0000 0000 0000 0000 0000 0001’, and all start codes are byte aligned.

A start code value is an 8-bit integer, and is configured for representing a type of the start code. Table 1 is a start code type table according to the embodiments of the present disclosure.

TABLE 1

| | Start code value |
|---|---|
| Start code type | (hexadecimal) |
| Point cloud sequence start code (sequence_start_code) | 00 |
| Point cloud sequence end code (sequence_end_code) | 01 |
| Geometric sequence start code (geometry_start_code) | 02 |
| Attribute sequence start code (attribute_start_code) | 03 |
| Point cloud frame start code (frame_start_code) | 04 |
| User data start code (user_data_start_code) | 05 |
| Point cloud geometric slice header start code | 06 |
| (gometry_slice_header_start_code) | |
| Point cloud attribute slice header start code | 07 |
| (attribute_slice_header_start_code) | |
| Geometric data start code | 08 |
| (geometry_slice_payload_start_code) | |
| Attribute data start code (attribute_slice_payload_start_code) | 09 |
| Color data start code (color_slice_payload_start_code) | 0A |
| Reflectivity data start code (refl_slice_payload_start_code) | 0B |
| Reserved | 0C-FF |

In the embodiments of the present disclosure, the point cloud sequence (PCC_sequence) is a top-level syntactic structure of the point cloud bit-stream. The point cloud sequence starts from a sequence header (sequence_header), and is followed by one or more point cloud frames. Each point cloud frame is to be preceded by a geometric header (geometry_header), an attribute header (attribute_header), and one or more pieces of point cloud slice data. The point cloud slice data includes a slice header and a data bit-stream. When the sequence header is successfully parsed, other data in the point cloud bit-stream continues to be parsed.

Alternatively, the point cloud sequence starts with the sequence header, the geometric header, and the attribute header, and is followed by one or more point cloud frames. Each point cloud frame is to be preceded by the frame header and one or more pieces of point cloud slice data. When the sequence header, the geometric header, and the attribute header are successfully parsed, other data in the bit-stream continues to be parsed.

The sequence header includes a parameter set required for decoding the point cloud sequence. The geometric header includes a parameter set required for decoding geometric data of the point cloud. The attribute header includes a parameter set required for decoding attribute data of the point cloud (such as target attribute data in this point cloud bit-stream).

The point cloud slice herein may include geometric slice information (which may be abbreviated as a geometric slice, geometry_slice), and may further include attribute slice information (which may be abbreviated as an attribute slice, attribute_slice). Each point cloud slice includes a slice header and a data bit-stream (geometry_data_bitstream).

The geometric slice includes two portions, namely, the geometric slice header and the geometric data bit-stream, and the geometric data bit-stream includes geometric data of the corresponding geometric slice. The attribute slice includes two portions, namely, the attribute slice header and the attribute data bit-stream (general_attribute_data_bit-stream), and the attribute data bit-stream includes attribute data of the corresponding attribute slice. To be specific, the slice header includes a geometric slice header and an attribute slice header, and the data bit-stream includes a geometric data bit-stream and an attribute data bit-stream.

Each portion of the foregoing point cloud sequence may include decoding indication information. In the embodiments of the present disclosure, a plurality of descriptive fields are mainly added to the sequence header, the frame header, the attribute header, and the attribute slice header and serve as decoding indication information, to support real-time operations of the point cloud processing method of the present disclosure.

FIG. 4 is a schematic flowchart of a point cloud processing method according to an embodiment of the present disclosure. The point cloud processing method may be applied to a decoding device, and in some embodiments, the decoding device may include a content presentation device. The data processing method may include the following operations.

Operation 011: A decoding end obtains decoding indication information of a point cloud bit-stream, the decoding indication information including at least one of a first indication parameter or a second indication parameter, the first indication parameter being set in sequence-level parameter information of a point cloud sequence, the second indication parameter being set in frame-level or slice-level parameter information of the point cloud sequence, the first indication parameter providing sequence-level decoding indication, and the second indication parameter providing frame-level or slice-level decoding indication.

Operation 012: The decoding end decodes the point cloud bit-stream according to the first indication parameter or the second indication parameter.

The point cloud bit-stream is a bit-stream structure obtained by encoding and compressing point cloud media, and may be extracted by a decoding device (such as the content presentation device) after decapsulating an encapsulated file. The point cloud media includes attribute data and geometric data. The attribute data may include a plurality of types, such as a color attribute and a reflectivity attribute. An encoding and compressing method may include geometry-based point cloud compression (GPCC), and the like.

The point cloud sequence is formed by a plurality of consecutive point cloud frames, and a frame number of the point cloud frame is a sequence number of the point cloud frame in the point cloud sequence.

The decoding indication information is configured for providing decoding indication for different data in the point cloud bit-stream. The decoding indication information may be set in a sequence header, a frame header, an attribute header, an attribute slice header, or the like.

A point cloud sequence may use the same attribute header and the same geometric header. To be specific, the sequence-level parameter information may include the sequence header, the attribute header, the geometric header, the point cloud bit-stream, and the like, and the frame-level parameter information may include the frame header. Alternatively, each point cloud frame includes the corresponding attribute header and geometric header. In this case, the sequence-level parameter information may include the sequence header, the point cloud bit-stream, and the like, and the frame-level parameter information may include the attribute header, the geometric header, the frame header, and the like. The slice-level parameter information may include a geometric slice, an attribute slice, a geometric data bit-stream, an attribute data bit-stream, and the like.

The sequence-level decoding indication information may be configured for providing decoding indication for each point cloud frame of the point cloud sequence. The frame-level decoding indication information may be configured for providing decoding indication for the corresponding point cloud frame (such as the point cloud frame in which the decoding indication information is located). The slice-level decoding indication information may be configured for providing decoding indication for the corresponding point cloud slice (such as the point cloud slice in which the decoding indication information is located).

For example, the decoding indication information set in the sequence header may be configured for providing decoding indication for each point cloud frame of the point cloud sequence. The decoding indication information set in the frame header may be configured for providing decoding indication for the corresponding point cloud frame. If the attribute header is the sequence-level parameter information, the decoding indication information set in the attribute header may be configured for providing attribute decoding indication for each point cloud frame of the point cloud sequence. The decoding indication information set in the attribute slice header may be configured for providing decoding indication for the corresponding point cloud slice.

The decoding indication information set in the sequence header, the attribute header, the frame header, and the attribute slice header is described below respectively.

### (1) Decoding Indication Information Set in the Sequence Header

The point cloud bit-stream may include a plurality of point cloud frames, and a plurality of consecutive point cloud frames form the point cloud sequence. The decoding indication information may be set in the sequence header of the point cloud sequence. The decoding indication information set in the sequence header of the point cloud sequence may be configured for providing decoding indication for each point cloud frame.

Before the decoding indication information set in the sequence header is described, syntactic elements of a general sequence header are described herein. The syntactic elements of the general sequence header are shown in Table 2.

TABLE 2

| | Descriptor |
|---|---|
| sequence_header( ) { | |
| sequence_start_code | f(32) |
| profile_id | u(8) |
| level_id | u(8) |
| marker_bit | f(1) |
| frameRate | ue(v) |
| bounding_box_offset_x_upper | u(16) |
| marker_bit | f(1) |
| bounding_box_offset_x_lower | u(16) |
| marker_bit | f(1) |
| bounding_box_offset_y_upper | u(16) |
| marker_bit | f(1) |
| bounding_box_offset_y_lower | u(16) |
| marker_bit | f(1) |
| bounding_box_offset_z_upper | u(16) |
| marker_bit | f(1) |
| bounding_box_offset_z_lower | u(16) |
| marker_bit | f(1) |
| bounding_box_size_width_upper | u(16) |
| marker_bit | f(1) |
| bounding_box_size_width_lower | u(16) |
| marker_bit | f(1) |
| bounding_box_size_height_upper | u(16) |
| marker_bit | f(1) |
| bounding_box_size_height_lower | u(16) |
| marker_bit | f(1) |
| bounding_box_size_depth_upper | u(16) |
| marker_bit | f(1) |
| bounding_box_size_depth_lower | u(16) |
| marker_bit | f(1) |
| geometry_quant_step_upper | u(16) |
| marker_bit | f(1) |
| geometry_quant_step_lower | u(16) |
| marker_bit | f(1) |
| geomRemoveDuplicateFlag | u(1) |
| attribute_present_flag | u(1) |
| if (attribute_present_flag) { | |
| colorQuantParam | ue(v) |
| reflQuantParam | ue(v) |
| maxNumAttributesMinus1 | u(7) |
| sps_multi_set_flag | u(1) |
| } | |
| byte_alignment( ) | |
| } | |

The syntactic elements in the general sequence header shown in Table 2 are explained below.

Profile number (profile id): an 8-bit unsigned integer. This syntactic element represents a profile to which the bit-stream conforms.

Level identification number (level id): an 8-bit unsigned integer. This syntactic element represents a level to which the bit-stream conforms.

Frame rate (frameRate): an unsigned integer. This syntactic element represents a frame rate (frames per second) of the point cloud sequence.

Upper 16-bit portion of an x coordinate of a bounding box origin (bounding_box_offset_x_upper): a 16-bit value. This syntactic element represents the upper 16 bits of a 32-bit signed integer of the x coordinate of the bounding box origin.

Lower 16-bit portion of the x coordinate of the bounding box origin (bounding_box_offset_x_lower): a 16-bit value. This syntactic element represents the lower 16 bits of a 32-bit signed integer of the x coordinate of the bounding box origin.

The x coordinate of the bounding box origin is that bounding_box_offset_x=(bounding_box_offset_x upper)<<16+bounding_box_offset_x_lower.

Upper 16-bit portion of a y coordinate of the bounding box origin (bounding_box_offset_y_upper): a 16-bit value. This syntactic element represents the upper 16 bits of a 32-bit signed integer of the y coordinate of the bounding box origin.

Lower 16-bit portion of the y coordinate of the bounding box origin (bounding_box_offset_y_lower): a 16-bit value. This syntactic element denotes the lower 16 bits of a 32-bit signed integer of the y coordinate of the bounding box origin.

The y coordinate of the bounding box origin is that bounding_box_offset_y=(bounding_box_offset_y_upper)<<16+bounding_box_offset_y_lower.

Upper 16-bit portion of a z coordinate of the bounding box origin (bounding_box_offset_z_upper): a 16-bit value. This syntactic element represents the upper 16 bits of a 32-bit signed integer in the z coordinate of the bounding box origin.

Lower 16-bit portion of the z coordinate of the bounding box origin (bounding_box_offset_z_lower): a 16-bit value. This syntactic element represents the lower 16 bits of a 32-bit signed integer of the z coordinate of the bounding box origin.

The z coordinate of the bounding box origin is that bounding_box_offset_z=(bounding_box_offset_z upper)<<16+bounding_box_offset_z_lower.

Upper 16-bit portion of a width of the bounding box (bounding_box_size_width_upper): a 16-bit value. This syntactic element represents the upper 16 bits of a 32-bit unsigned integer of the width of the bounding box.

Lower 16-bit portion of the width of the bounding box (bounding_box_size_width_lower): a 16-bit value. This syntactic element represents the lower 16 bits of a 32-bit unsigned integer of the width of the bounding box.

The width of the bounding box is that bounding_box_size_width=(bounding_box_size_width_upper)<<16+bounding_box_size_width_lower.

Upper 16-bit portion of a height of the bounding box (bounding_box_size_height_upper): a 16-bit value. This syntactic element represents the upper 16 bits of a 32-bit unsigned integer of the height of the bounding box.

Lower 16-bit portion of the height of the bounding box (bounding_box_size_height_lower): a 16-bit value. This syntactic element represents the lower 16 bits of the 32-bit unsigned integer of the height of the bounding box.

The height of the bounding box is that bounding_box_size_height=(bounding_box_size_height_upper)<<16+bounding_box_size_height_lower.

Upper 16-bit portion of a depth of the bounding box (bounding_box_size_depth_upper): a 16-bit value. This syntactic element represents the upper 16 bits of a 32-bit unsigned integer of the depth of the bounding box.

Lower 16-bit portion of the depth of the bounding box (bounding_box_size_depth_lower): a 16-bit value. This syntactic element represents the lower 16 bits of the a 32-bit unsigned integer of the depth of the bounding box.

The depth of the bounding box is that bounding_box_size_depth=(bounding_box_size_depth_upper)<<16+bounding_box_size_depth_lower.

Upper 16-bit portion of a geometric quantization step length (geometry_quant_step_upper): a 16-bit value. This syntactic element represents the upper 16 bits of a 32-bit floating-point number of the geometric quantization step length.

Lower 16-bit portion of the geometric quantization step length (geometry_quant_step_lower): a 16-bit value. This syntactic element represents the lower 16 bits of a 32-bit floating-point number of the geometric quantization step length.

The quantization step length is that geometry_quant_step=(float)((geometry_quant_step_upper<<16)+geometry_quant_step_lower).

Geometric removal duplicate point flag (geomRemovable DuplicateFlag): a binary variable. A value of ‘1’ indicates that duplicate points, namely, the points having same geometric positions, are removed before geometric encoding. A value of ‘0’ indicates that no duplicate point is removed.

An attribute presence flag (attribute_present_flag): a binary variable. A value of ‘1’ indicates that the current bit-stream includes an attribute code; and a value of ‘0’ indicates that the current bit-stream does not include the attribute code, namely, does not include the attribute header, the attribute slice header, and the attribute information.

Multiple attribute information start flag (sps_multi_set_flag): a binary variable. A value of ‘1’ indicates that support for using multiple sets of attribute information for the same attribute data is enabled; and a value of ‘0’ indicates that support for using multiple sets of attribute information for the same attribute data is disabled, and only one set of attribute information may be used for same attribute data. When sps_multi_set_flag is not present in the bit-stream, a default value is zero.

Maximum attribute number minus one (maxNumAttributesMinus1): an unsigned integer. Plus 1 indicates an encoding number of maximum attribute types supported by this standard bit-stream, and a value range is [0, 127]. When maxNumAttributesMinus1 is not present in the bit-stream, maxNumAttributesMinus1 is −1 by default.

Color quantization parameter (colorQuantParam): an unsigned integer. This syntactic element represents a color attribute quantization parameter.

Reflectivity quantization parameter (reflQuantParam): an unsigned integer. This syntactic element represents a reflectivity attribute quantization parameter.

### (2) Decoding Indication Information Set in the Frame Header

The point cloud bit-stream may include a plurality of point cloud frames. The decoding indication information may be set in the frame header of the point cloud frame. The decoding indication information set in the frame header of the point cloud frame may be configured for providing decoding indication for the point cloud frame corresponding to the frame header.

Before the decoding indication information set in the frame header is described, syntactic elements of the general frame header are described herein. The syntactic elements of the general frame header are shown in Table 3.

TABLE 3

| | Descriptor |
|---|---|
| frame_header( ) { | |
| frame_start_code | f(32) |
| frame_idx | ue(v) |
| frame_num_slice_minus_one | ue(v) |
| geom_num_points_upper | u(16) |
| geom_num_points_lower | u(16) |
| byte_alignment( ) | |
| } | |

The syntactic elements in the general frame header shown in Table 3 are explained below.

Frame index (frame_idx): this field indicates an index of the point cloud frame in the point cloud sequence, and a value range of the frame index of the point cloud frame is [0, 65535]. A frame index of each point cloud frame is a frame index of a preceding point cloud frame plus 1, and the frame index of a first point cloud frame is 0. After the frame index of a point cloud frame reaches 65535, the frame index of a subsequent point cloud frame is reset to 0.

Intra-frame point cloud slice number minus one (frame_num_slice_minus_one): a value of this field is a number of point cloud slices in the current point cloud frame minus one.

Upper 16-bit portion of a total number of points of the point cloud (geom_num_points_upper): a 16-bit value. This field represents the upper 16 bits of a 32-bit unsigned integer of the number of points after geometric quantization and duplication removal of the point cloud.

Lower 16-bit portion of the total number of points of the point cloud (geom_num_points_lower): a 16-bit value. This field represents the lower 16 bits of a 32-bit unsigned integer of the number of points after geometric quantization and duplication removal of the point cloud.

The number of points is that geom_num_points=(geom_num_points_upper)<<16+geom_num_points_lower.

### (3) Decoding Indication Information Set in the Attribute Header

The point cloud bit-stream may include a plurality of point cloud frames. The decoding indication information may be set in the attribute header of the point cloud frame. The decoding indication information set in the attribute header of the point cloud frame may be configured for providing attribute decoding indication for the point cloud frame.

Before the decoding indication information set in the attribute header is described, the syntactic elements of the general attribute header are described herein. The syntactic elements of the general attribute header are shown in Table 4.

TABLE 4

| | Descriptor |
|---|---|
| attribute_header( ) { | |
| attribute_start_code | f(32) |
| for ( attrIdx = 0; attrIdx < (maxNumAttributesMinus1 + 1); attrIdx ++ | |
| ){ | |
| attributePresentFlag[attrIdx] | u(1) |
| if(attributePresentFlag[attrIdx]){ | |
| attribute_data_num_set_minus1[attrIdx] | ue(v) |
| if((attrIdx == 1) && (attribute_data_num_set_minus1[1]>0)){ | |
| for(i=0;i< ((attribute_data_num_set_minus1 [1]+1); i++){ | |
| multi_attr_group_id [i] | ue(v) |
| } | |
| } | |
| if(sps_multi_set_flag) | |
| multi_set_flag[attrIdx] | u(1) |
| if(multi_set_flag[attrIdx]) | |
| attribute_info_num_set_minus1[attrIdx] | ue(v) |
| for(i=0;i< (attribute_info_num_set_minus1[attrIdx]+1); i++){ | |
| outputBitDepthMinus1[attrIdx][i] | ue(v) |
| if (attrIdx == 0) { | |
| orderSwitch [i] | u(1) |
| colorReorderMode[i] | ue(v) |
| colorGolombNum[i] | ue(v) |
| log2_golomb_group_size[i] | ue(v) |
| } | |
| if (attrIdx == 1) { | |
| axisBias [i] | ue(v) |
| refReorderMode[i] | ue(v) |
| refGolombNum[i] | ue(v) |
| predFixedPointFracBit[i] | ue(v) |
| if(attribute_data_num_set_minus1[1]>0){ | |
| multi_attr_group_id [i] | ue(v) |
| } | |
| } | |
| transform[attrIdx][i] | u(2) |
| if((transform [attrIdx][i]== 0) \|\| (transform [attrIdx][i]== 2)){ | |
| maxNumOfNeighboursLog2Minus7[attrIdx][i] | u(2) |
| if (attrIdx == 0 ) { | |
| cross_component_Pred[i] | u(1) |
| chromaQpOffsetCb[i] | se(v) |
| chromaQpOffsetCr[i] | se(v) |
| } | |
| if(attrIdx == 1){ | |
| nearestPredParam1[i] | ue(v) |
| nearestPredParam2[i] | ue(v) |
| log2_pred_dist_weight_group_size[i] | ue(v) |
| } | |
| } | |
| if(transform[attrIdx][i] == 1) { | |
| kFracBits[attrIdx][i] | ue(v) |
| attrTransformQpDelta[attrIdx][i] | ue(v) |
| transformSegmentSize[attrIdx][i] | ue(v) |
| transResLayer[attrIdx][i] | u(1) |
| if (attrIdx == 0) { | |
| colorInitPredTransRatio[i] | se(v) |
| } | |
| if (attrIdx == 1) { | |
| refInitPredTransRatio[i] | se(v) |
| } | |
| } | |
| if (transform[attrIdx][i] == 2 ) { | |
| log2maxNumofCoeffMinus8[attrIdx][i] | ue(v) |
| QpOffsetDC[attrIdx][i] | se(v) |
| QpOffsetAC[attrIdx][i] | se(v) |
| if (attrIdx == 0) { | |
| colorMaxTransNum[i] | ue(v) |
| chromaQpOffsetDC[i] | se(v) |
| chromaQpOffsetAC[i] | se(v) |
| colorQPAdjustFlag[i] | u(1) |
| if(colorQPAdjustFlag[i]){ | |
| colorQPAdjustScalar[i] | ue(v) |
| } | |
| } | |
| if (attrIdx == 1) { | |
| refMaxTransNum [i] | ue(v) |
| refGroupPred [i] | u(1) |
| } | |
| } | |
| log2coeffLengthControlMinus8[attrIdx][i] | ue(v) |
| } | |
| } | |
| } | |
| if ((attribute_data_num_set_minus1[0] == 0) && | |
| (attribute_data_num_set_minus1[1] == 0)) { | |
| crossAttrTypePred | u(1) |
| if (crossAttrTypePred){ | |
| attrEncodeOrder | u(1) |
| crossAttrTypePredParam1 | u(15) |
| crossAttrTypePredParam2 | u(21) |
| } | |
| } | |
| byte_alignment( ) | |
| } | |

The syntactic elements in the general attribute header shown in the Table 4 are explained below.

Attribute present flag field (attributePresentFlag[attrIdx]): a binary variable. A value of ‘1’ indicates that the point cloud bit-stream includes an attrIdx^{th} attribute code (namely, an attribute code under an attribute type whose attribute index is attrIdx); and a value of ‘0’ indicates that the point cloud bit-stream does not include the attrIdx^{th} attribute code. attrIdx represents the attribute index, and is an integer ranging from 0 to 15.

Meanings of attrIdx are explained in Table 5 below.

TABLE 5

| attrIdx | Attribute description |
|---|---|
| 0 | Color |
| 1 | Reflection |
| 2 . . . 15 | Reserved |

Attribute data number minus one field (attribute_data_num_set_minus1[attrIdx]): an unsigned integer. Plus 1 indicates a number of multiple attribute data sets supported by an attribute determined by the attribute index attrIdx in the point cloud bit-stream. This is a number ranging from 0 to 127. When attribute_data_num_set_minus1[attrIdx] is not present in the point cloud, a default value is −1.

Attribute information enable flag field (multi_set_flag[attrIdx]): a binary variable. A value of ‘1’ indicates that the attribute determined by the attribute index attrIdx is enabled to support use of multiple sets of attribute information; and a value of ‘0’ indicates that the attribute determined by the attribute index attrIdx is disabled to support use of multiple sets of attribute information, and the attribute data may only use one set of attribute information. When multi_set_flag[attrIdx] is not present in the bit-stream, a default value is zero.

Attribute information number minus one field (attribute_info_num_set_minus1[attrIdx]): an unsigned integer. Plus 1 indicates a number of pieces of attribute information supported by the attribute determined by the attribute index attrIdx in the point cloud bit-stream, and this is a number ranging from 0 to 127; and when attribute_info_num_set_minus1[attrIdx] is not present in the bit-stream, a default value is −1.

Attribute transform algorithm flag field (transform): an unsigned integer, ranging from 0 to 2. This field is configured for controlling an attribute encoding mode. When the value is ‘0’, an attribute prediction mode is employed to encode the attribute; when the value is ‘1’, a multi-layer transform mode is employed to encode the attribute; and when the value is ‘2’, an attribute prediction and transform mode is employed to encode the attribute.

Attribute transform accuracy value (kFracBits): an unsigned integer. This field is configured for representing shift accuracy of a fixed-point operation during attribute transform.

Attribute transform coefficient quantization parameter difference field (attrTransformQpDelta): an unsigned integer. This field is configured for representing a difference from an attribute residual quantization parameter. Attribute transform coefficient quantization parameter: attrTransformQp=attrQuantParam+attrTransformQpDelta.

Attribute transform point number field (attrTransformNumPoints): an unsigned integer. This field is configured for representing a number of points for attribute transform, namely, wavelet transform using attrTransformNumPoints points. attrTransformNumPoints=0 indicates that all points in a slice are used for wavelet transform.

Maximum searched neighbor point number logarithmic value minus seven field (maxNumOfNeighbour_log 2_minus7): an unsigned integer. This field is configured for exporting a variable maxNumOfNeighbour, which represents a maximum number of encoded neighbor points available for search, to control a search range for neighbor candidate points during attribute prediction and a number of points stored in hardware cache. maxNumOfNeighbour is obtained by using the following formula: maxNumOfNeighbour=2 (maxNumOfNeighbor_log 2_minus7+7), where maxNumOfNeighbour_log 2_minus7 is an integer ranging from 0 to 3.

Attribute residual secondary prediction field (cross_component_pred): a binary variable. A value of ‘1’ indicates that secondary prediction of an attribute residual is allowed; and a value of ‘0’ indicates that secondary prediction of the attribute residual is not allowed.

Residual encoding order switch field (orderSwitch): a binary variable. A value of ‘1’ indicates that a residual encoding order is UYV/GSB; and a value of ‘0’ indicates that the residual encoding order is YUV/RGB.

Chrominance channel Cb quantization parameter offset field (chromaQpOffsetCb): a signed integer. This field is configured for controlling a Cb channel quantization parameter, with a value ranging from −16 to 16. If no chromaQpOffsetCb is present in an attribute header, the value of chromaQpOffsetCb is 0, n amely, choramQpCb=Clip3(minQP,maxQP,attribute_qp+chromaQpOffsetCb). A quantization parameter of a luminance channel lumaQp=attribute_qp, a minimum supported quantization parameter is minQP=0, and a maximum supported quantization parameter is maxQP=63.

Chrominance channel Cr quantization parameter offset field (chromaQpOffsetCr): a signed integer. This field is configured for controlling a Cr channel quantization parameter, with a value ranging from −16 to 16. If chromaQpOffsetCr is not present in the attribute header, the value of chromaQpOffsetCr is 0, namely, choramQpCr=Clip3(minQP,maxQP,attribute_qp+chromaQpOffsetCr). A quantization parameter of a luminance channel lumaQp=attribute_qp, a minimum supported quantization parameter is minQP=0, and a maximum supported quantization parameter is maxQP=63.

Nearest neighbor point prediction parameter field 1 (nearestPredParam1): an unsigned integer. This field is configured for controlling a predicted threshold of a nearest neighbor point.

Nearest neighbor point prediction parameter field 2 (nearestPredParam2): an unsigned integer. This field is configured for controlling a predicted threshold of a nearest neighbor point. The predicted threshold of the nearest neighbor point is expressed as attrQuantParam*nearestPredParam1+nearestPredParam2.

Space bias coefficient field (axisBias): an unsigned integer. This field is configured for controlling an offset in a Z direction during calculation of attribute prediction information.

Attribute output bit depth minus one field (outputBitDepthMinus1): an unsigned integer. This field is configured for controlling an attribute output bit depth, with a value ranging from 0 to 15. The attribute output bit depth outputBitDepth=outputBitDepthMinus1+1. If the syntactic element is not present in the bit-stream, a default value is zero.

Color reordering mode field (colorReorderMode): an unsigned integer. This field is configured for representing a reordering mode selected by current color information. A value of ‘0’ indicates an original point cloud input order, a value of ‘1’ indicates Hilbort reordering, and a value of ‘2’ indicates Morton reordering.

Reflectivity reordering mode field (reflReorderMode): an unsigned integer. This field is configured for representing a reordering mode selected by current reflectivity information. A value of ‘0’ indicates an original point cloud input order, a value of ‘1’ indicates Hilbort reordering, and a value of ‘2’ indicates Morton reordering.

Maximum cache limitation parameter field (log 2maxNumofCoeffMinus8): an unsigned integer, with a value ranging from 0 to 16.

The maximum cache limitation parameter maxNumofCoeff of a transform coefficient is calculated by using the following formula: maxNumofCoeff=1<<(log 2maxNumofCoeffMinus8+8). When log 2maxNumofCoeffMinus8 is not present in the bit-stream, a default value of the maxNumofCoeff is 1.

Maximum latency limitation parameter field (log 2coeffLengthControlMinus8): an unsigned integer. This field is configured for limiting a number of maximum latencies of transform parameters in attribute transform encoding. The specific maximum latency number is calculated as maxLatency=maxNumofCoeff*(1<<(log 2coeffLengthControlMinus8+8)). A maximum value of maxLatency is 131072.

Attribute encoding order field (attrEncodeOrder): a binary variable. This field is configured for controlling an encoding order of attributes when the point cloud includes a plurality of attribute types. A value of ‘0’ indicates that color is encoded first and then reflectivity is encoded; and a value of ‘1’ indicates that the reflectivity is encoded first, and then the color is encoded.

Adaptive exponential-Golomb encoding sliding window size field (log 2_golomb_group_size): an unsigned integer. This field indicates a logarithmic value of a size of an adaptive exponential-Golomb encoding sliding window of an attribute prediction residual or a transform coefficient. The size of the adaptive exponential-Golomb encoding sliding window is expresses as: golomb_sliding_window_size=2 log 2_golomb_group_size.

Cross-type attribute prediction field (crossAttrTypePred): a binary variable. A value of ‘1’ indicates that cross-type attribute prediction is allowed; and a value of ‘0’ indicates that the cross-type attribute prediction is not allowed.

Cross-type attribute prediction weight parameter 1 (crossAttrTypePredParam1): a 15-bit unsigned integer. This field is configured for controlling a weight parameter 1 for calculating a geometric information distance and an attribute information distance during cross-type attribute prediction.

Cross-type attribute prediction weight parameter 2 (crossAttrTypePredParam2): a 21-bit unsigned integer. This field is configured for controlling a weight parameter 2 for calculating a geometric information distance and an attribute information distance during cross-type attribute prediction.

Reflectivity group prediction flag field (refGroupPred): a binary variable. This field is configured for controlling whether a reflectivity group prediction mode for prediction transform is enabled, where group prediction is enabled when the value is ‘1’, and group prediction is disabled when the value is ‘0’.

Color initial prediction transform ratio (colorInitPredTransRatio): a signed integer. This field is configured for controlling an initial distance threshold for color during construction of a prediction and transform tree in a multilayer transform algorithm for attribute compression (transform=1).

Reflectivity initial prediction transform ratio (refInitPredTransRatio): a signed integer. This field is configured for controlling an initial distance threshold for reflectivity during construction of the prediction and transform tree in the multilayer transform algorithm for attribute compression (transform=1).

Transform residual layer flag field (transResLayer): a binary variable. This field is configured for controlling whether to use attribute residual compensation in the multilayer transform algorithm for the attribute compression (transform=1). When transResLayer=1, the attribute residual compensation is used; and when transResLayer=0, the attribute residual compensation is not used.

Color exponential-Golomb order number (ColorGolombNum): an unsigned integer, ranging from 0 to 8. This field is configured for indicating an order number K=ColorGolombNum of K-order exponential Golomb used when a current color prediction residual or a transform coefficient is decoded.

Reflectivity exponential-Golomb order number (RefGolombNum): an unsigned integer, ranging from 0 to 8. This field is configured for indicating an order number K=ColorGolombNum of K-order exponential Golomb used when a current reflectivity prediction residual or a transform coefficient is decoded.

Point cloud adaptive quantization tool flag field (colorQPAdjustFlag): a binary variable. A value of ‘0’ indicates that a point cloud adaptive quantization tool is disabled; and a value of ‘1’ indicates that the point cloud adaptive quantization tool is enabled.

Ratio of a number of points before and after point cloud geometric quantization (colorQPAdjustScalar): an unsigned integer. This field is configured for calculating a distance threshold of a point cloud adaptive quantization tool.

Reflectivity attribute prediction accuracy value (predFixedPointFracBit): an unsigned integer. This field is configured for indicating shift accuracy of a fixed-point operation during reflectivity attribute prediction. predFixedPointFracBit=0 indicates that the fixed-point operation is not used.

Attribute value variation statistics window size (log 2_pred_dist_weight_group_size): unsigned integer. This field is configured for controlling a size of an attribute value variation statistics window. The window size is calculated as N=2 log 2_pred_dist weight_group_size.

Maximum color transform order number (colorMaxTransNum): an unsigned integer, with a value range of [0, 8]. This field is configured for indicating a maximum transform order number in current color prediction and transform.

Maximum reflectivity transform order number (refMaxTransNum): an unsigned integer, with a value range of [0, 8]. This field is configured for indicating a maximum transform order number in current reflectivity prediction and transform.

Multi-attribute grouping parameter (multi_attr_group_id): an unsigned integer array. When attribute_data_num_set_minus1[1] is greater than 0, this field defines a grouping situation of a multi-reflectivity attribute, where attributes in the same group need to be decoded together as a group from an attribute data bit-stream. multi_attri_group_id[i] indicates that an i^{th} piece of attribute data belongs to a (multi_attri_group_id[i])^{th} attribute group, with a value ranging from 0 to 127. A value of multi_attr_group_id[0] is 0, and a value of a latter element in the array is equal to or greater than a value of a preceding element by 1. It is defined that multi_attri_group_num denotes a number of pieces of attribute data in the (multi_attri_group_id[i])^{th} attribute group, and may be obtained by accumulating the number of consecutive multi_attri_group_id[i] points.

The syntactic elements of the general attribute header of the point cloud frame are described above.

### (4) Decoding Indication Information Set in the Attribute Slice Header

The decoding indication information may be set in the attribute slice header, and the decoding indication information set in the attribute slice header may be configured for providing attribute decoding indication for the point cloud slice.

Before the decoding indication information set in the attribute slice header is described, the syntactic elements of the general attribute slice header are described herein. The syntactic elements of the general attribute slice header are shown in Table 6.

TABLE 6

| | Descriptor |
|---|---|
| attribute_slice_header( ) { | |
| attribute_slice_header_start_code | f(32) |
| slice_id | ue(v) |
| attributeID | ue(v) |
| reflQPoffset | se(v) |
| byte_alignment( ) | |
| } | |

The syntactic elements in the general attribute slice header shown in Table 6 are explained below.

Slice identification number (slice id): an unsigned integer. This syntactic element indicates an identification number of a slice.

Attribute information index (attributeID): an unsigned integer. This syntactic element specifies an (attributeID)^{th} group of attribute information for a corresponding attribute type in the attribute header used by the attribute slice, and this value ranges from 0 to attribute_info_num_set_minus1[attrIdx]+1 (when the attribute slice is a color attribute slice, attrIdx corresponds to 0; and when the attribute slice is a reflectivity attribute slice, attrIdx corresponds to 1). When the syntactic element is not present in the bit-stream, a default value is 0.

Reflectivity attribute quantization parameter offset (reflQPoffset): a signed integer. This syntactic element is configured for controlling the reflectivity attribute quantization parameter, with a value range of [−32 to 32].

In the embodiments of the present disclosure, the first indication parameter is set in the sequence-level parameter information, for example, set in a sequence header, and configured for providing decoding indication for each point cloud frame in the point cloud bit-stream. The second indication parameter is set in the frame-level or slice-level parameter information. For example, the second indication parameter is set in a frame header, and configured for providing decoding indication for the corresponding point cloud frame (namely, the point cloud frame corresponding to the frame header in which the second indication parameter is located); or if the second indication parameter is set in the slice header (such as a geometric slice header or an attribute slice header), and configured for providing decoding indication for the corresponding point cloud slice (namely, the point cloud frame corresponding to the slice header in which the second indication parameter is located). If the slice header is the geometric slice header, geometric decoding indication is provided for the corresponding geometric slice. If the slice header is an attribute slice header, attribute decoding indication is provided for the corresponding attribute slice.

The second indication parameter is generally a geometric or attribute frame-wise or slice-wise variable parameter. For example, since the point cloud is different, bounding box related parameters corresponding to each point cloud frame are generally different; or quantization parameters of the point cloud frames are different; or color initial prediction and transform ratios (colorInitPredTransRatio) of the point cloud slices are different.

The first indication parameter is configured for providing uniform decoding indication for all point cloud frames (for example, all point cloud frames of the point cloud sequence), and to be specific, each point cloud frame may be decoded by using the first indication parameter. The second indication parameter provides the decoding indication only for the point cloud frame in which the frame header is located or the point cloud slice in which the slice header is located; and to be specific, each point cloud frame may be decoded according to the second indication parameter in the frame header, and each point cloud slice may be decoded according to the second indication parameter in the slice header.

In the present disclosure, after the decoding indication information of the point cloud bit-stream is obtained, the first indication parameter located in the sequence header and/or the second indication parameter located in the frame header or the slice header may be obtained from the decoding indication information.

During decoding, if the decoding indication information includes only the first indication parameter but not the second indication parameter, the first indication parameter in the sequence header may be selected to decode each point cloud frame in the point cloud bit-stream, so that parameters corresponding to the point cloud frames, such as the bounding box related parameters, and the quantization parameter corresponding to each point cloud frame, do not need to be calculated frame by frame, thereby reducing calculation amount required for decoding and improving the decoding efficiency.

Alternatively, during decoding, if the decoding indication information includes only the second indication parameter but not the first indication parameter, the second indication parameter in the frame header of each point cloud frame may be selected to decode the corresponding point cloud frame, or the second indication parameter in the slice header of each point cloud slice may be selected to decode the corresponding point cloud slice. To avoid an indication conflict, the second indication parameter is generally defined only in the frame header or the slice header in the same point cloud frame, and the second indication parameter is not defined in both the frame header and the slice header. If the second indication parameter of each frame header or slice header includes the bounding box related parameter, the quantization parameter, or the like, the corresponding point cloud frame is decoded frame by frame or slice by slice by using the second indication parameter, thereby enhancing decoding accuracy of the point cloud.

The bounding box related parameter may include a bounding box origin coordinate field and a bounding box size field.

The bounding box origin coordinate field includes an upper 16-bit portion (bounding_box_offset_x upper) of an x coordinate of the bounding box origin, a lower 16-bit portion (bounding_box_offset_x_lower) of the x coordinate of the bounding box origin, an upper 16-bit portion (bounding_box_offset_y_upper) of a y coordinate of the bounding box origin, a lower 16-bit portion (bounding_box_offset_y_lower) of the y coordinate of the bounding box origin, an upper 16-bit portion (bounding_box_offset_z upper) of a z coordinate of the bounding box origin, and a lower 16-bit portion (bounding_box_offset_z_lower) of the z coordinate of the bounding box origin.

The bounding box size field includes an upper 16-bit portion (bounding_box_size_width upper) of a width of the bounding box, a lower 16-bit portion (bounding_box_size_width_lower) of the width of the bounding box, an upper 16-bit portion (bounding_box_size_height_upper) of a height of the bounding box, a lower 16-bit portion (bounding_box_size_height_lower) of the height of the bounding box, an upper 16-bit portion (bounding_box_size_depth_upper) of a depth of the bounding box, a lower 16-bit portion (bounding_box_size_depth_lower) of the depth of the bounding box.

The quantization parameter may include a geometric quantization parameter, an attribute quantization parameter, and the like.

For example, Table 7 is a syntactic definition table of a sequence header according to an embodiment of the present disclosure, and includes a first indication parameter such as a bounding box related parameter. Table 8 is a syntactic definition table of a frame header according to an embodiment of the present disclosure, and includes a second indication parameter such as the bounding box related parameter and a color initial prediction transform ratio. Table 9 is a syntactic definition table of a slice header (specifically, an attribute slice header) according to an embodiment of the present disclosure, and includes a second indication parameter such as a color initial prediction transform ratio. Table 7, Table 8, and Table 9 are not defined as complete syntactic definition tables.

TABLE 7

| | Descriptor |
|---|---|
| sequence_header( ) { | |
| ... | |
| global_bounding_box_flag | u(1) |
| if(global_bounding_box_flag){ | |
| bounding_box_offset_x_upper | u(16) |
| marker_bit | f(1) |
| bounding_box_offset_x_lower | u(16) |
| marker_bit | f(1) |
| bounding_box_offset_y_upper | u(16) |
| marker_bit | f(1) |
| bounding_box_offset_y_lower | u(16) |
| marker_bit | f(1) |
| bounding_box_offset_z_upper | u(16) |
| marker_bit | f(1) |
| bounding_box_offset_z_lower | u(16) |
| marker_bit | f(1) |
| bounding_box_size_width_upper | u(16) |
| marker_bit | f(1) |
| bounding_box_size_width_lower | u(16) |
| marker_bit | f(1) |
| bounding_box_size_height_upper | u(16) |
| marker_bit | f(1) |
| bounding_box_size_height_lower | u(16) |
| marker_bit | f(1) |
| bounding_box_size_depth_upper | u(16) |
| marker_bit | f(1) |
| bounding_box_size_depth_lower | u(16) |
| marker_bit | f(1) |
| } | |
| ... | |
| byte_alignment( ) | |
| } | |

TABLE 8

| | Descriptor |
|---|---|
| frame_header( ) { | |
| frame_idx | ue(v) |
| frame_num_slice_minus_one | ue(v) |
| geom_num_points_upper | u(16) |
| geom_num_points_lower | u(16) |
| marker_bit | f(1) |
| if(!global_bounding_box_flag){ | |
| frame_bounding_box_offset_x_upper | u(16) |
| marker_bit | f(1) |
| frame_bounding_box_offset_x_lower | u(16) |
| marker_bit | f(1) |
| frame_bounding_box_offset_y_upper | u(16) |
| marker_bit | f(1) |
| frame_bounding_box_offset_y_lower | u(16) |
| marker_bit | f(1) |
| frame_bounding_box_offset_z_upper | u(16) |
| marker_bit | f(1) |
| frame_bounding_box_offset_z_lower | u(16) |
| marker_bit | f(1) |
| frame_bounding_box_size_width_upper | u(16) |

TABLE 9

| | Descriptor |
|---|---|
| attribute_slice_header( ) { | |
| attribute_slice_header_start_code | f(32) |
| slice_id | ue(v) |
| attributeID | ue(v) |
| reflQPoffset | se(v) |
| colorInitPredTransRatio | |
| byte_alignment( ) | |
| } | |

For explanations of fields in Table 7, Table 8, and Table 9, refer to Table 2, Table 3, and Table 6, and details are not described herein again.

According to the point cloud processing method in the present disclosure, the decoding indication information of the point cloud bit-stream is obtained, the sequence-level first indication parameter and the frame-level or slice-level second indication parameter are defined in the decoding indication information, the first indication parameter is set in the sequence-level parameter information of the point cloud sequence, and the second indication parameter is set in the frame-level or slice-level parameter information of the point cloud sequence, and then decoding is performed according to the first indication parameter or the second indication parameter. When decoding is performed according to the sequence-level first indication parameter, each point cloud frame of the point cloud sequence is decoded by using the unified first indication parameter without parsing the indication parameter corresponding to each point cloud frame, so that the decoding efficiency is relatively high. When decoding is performed according to the frame-level or slice-level second indication parameter, frame-level or slice-level decoding may be implemented according to the second indication parameter, so that each point cloud frame or point cloud slice has an adaptive second indication parameter, and frame-by-frame or slice-by-slice variation of the second indication parameter is achieved. Compared with the method where each parsing of point cloud frame requires parsing the sequence header to obtain the indication parameter corresponding to the point cloud frame for decoding, resulting in relatively low decoding efficiency, the corresponding indication parameter does not need to be parsed from the sequence header for each point cloud frame, so that the corresponding second indication parameter can be obtained quickly, and the decoding efficiency is relatively high.

In some embodiments, in response to that the decoding indication information includes both the first indication parameter and the second indication parameter, a third indication parameter may be set in the sequence header. The third indication parameter is configured for indicating whether decoding is performed according to the first indication parameter or the second indication parameter.

Still referring to Table 7 and Table 8, the bounding box related parameter is taken as an example. The third indication parameter is a bounding box flag bit (global_bounding_box_flag), and in response to that global_bounding_box_flag is a first preset value (such as true), each point cloud frame of the point cloud sequence may be decoded according to the first indication parameter. In response to that global_bounding_box_flag is a second preset value (such as false), each point cloud frame of the point cloud sequence may be decoded according to the second indication parameter.

In some embodiments, the first indication parameter is determined according to the second indication parameter of each point cloud frame.

For example, the first indication parameter is determined according to a maximum value of the second indication parameter of each point cloud frame, the first indication parameter includes a maximum x coordinate, y coordinate, and z coordinate of the bounding box, and a maximum width, a maximum height, and a maximum depth.

In some embodiments, the first indication parameter is a preset value.

For example, the preset value may be an empirical value, or a value agreed on by an encoding end and a decoding end in advance.

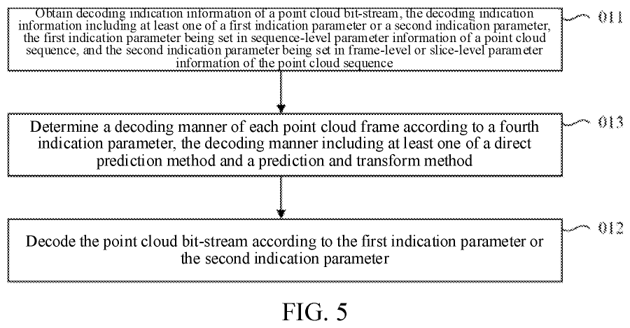

In some embodiments, referring to FIG. 5, the decoding indication information further includes a fourth indication parameter, the fourth indication parameter is configured for indicating a grouping manner of each point cloud frame, and the point cloud processing method further includes:

Operation 013: A decoding end determines a decoding manner of each point cloud frame according to the fourth indication parameter, the decoding manner including at least one of a direct prediction method and a prediction and transform method.

The decoding manner refers to a method used by the decoding end for decoding, and mainly includes at least one of a direct prediction method and a prediction and transform method. Taking a decoding attribute bit-stream as an example, in the direct prediction method, a residual value of each point of a current group is mainly obtained by parsing, to obtain a predicted value of each point, thereby determining reconstructed attribute information of the current point; and in the prediction and transform method, a transform coefficient of the current group is mainly obtained by parsing, and the residual value of the current group is obtained after inverse transform, to obtain the predicted value of each point, thereby determining reconstructed attribute information of the current point.

In some embodiments, for different grouping manners, corresponding decoding manners need to be used to ensure the decoding efficiency. To enable the decoding end to determine the decoding manner for decoding, decoding indication is needed, to enable the decoding end to determine the specific decoding manner.

The decoding indication information further includes the fourth indication parameter. The decoding manner corresponding to the fourth indication parameter may be determined by using the fourth indication parameter indicating the grouping manner of the point cloud frames.

In some embodiments, the fourth indication parameter may be set in an appropriate position such as a sequence header, a frame header, an attribute header, or a data bit-stream (such as a geometric bit-stream or an attribute bit-stream). This is not limited herein, as long as it is ensured that the decoding end can obtain the grouping manner through parsing, to determine the corresponding decoding manner.

In some embodiments, the fourth indication parameter is not set in the decoding indication information, the decoding manner of the decoding end is a default manner agreed on with an encoding end, and a default manner is used to implement decoding.

In some embodiments, the grouping manner includes at least one of the following manners:
(1) Dividing points in each group into a plurality of sub-groups according to a preset grouping threshold, and performing grouping for a latter sub-group after a number of points of a preceding sub-group reaches the preset grouping threshold, where the preset grouping threshold is configured for indicating a number of points included in one sub-group;
(2) supplementing a current sub-group with a current point in response to that the current point for grouping is a duplicate point, and dividing each of the remaining duplicate points into a separate sub-group until the number of the points of the current sub-group reaches the preset grouping threshold, where the duplicate point is a point that is the same as any point in the group to which the point belongs or as any point among previous N points, and N is a positive integer;
(3) supplementing the current sub-group with the current point in response to that the current point for grouping is the duplicate point, and stopping continuous grouping for the remaining duplicate points until the number of the points in the current sub-group reaches the preset grouping threshold;
(4) determining, in response to that the current point for grouping is the duplicate point, that grouping for the current sub-group is completed, and continuing grouping for the remaining points according to the preset grouping threshold;
(5) determining, in response to that the current point for grouping is the duplicate point, that grouping for the current sub-group is completed, and dividing each of the remaining duplicate points into a separate sub-group; and
(6) determining, in response to that the current point for grouping is the duplicate point, that grouping for the current sub-group is completed, and stopping continuous grouping for the remaining duplicate points.

Specifically, during grouping, the decoding end may first perform grouping according to an initial right-shift number, and perform right shift on a code (such as a Hilbort code) corresponding to each point according to the initial right-shift number, to obtain a right-shifted value. If a code of the current point is a 10-bit binary value, and the initial right-shift number is 3, a value (such as a 10-bit value denoted in binary, a 7-bit value from right to left) formed by remaining 7 bits may be obtained. Then, based on the obtained right-shifted values, the points with same values are determined to be in a same group, thereby obtaining a plurality of groups.

Then, the decoding end further divides each group, to obtain sub-groups corresponding to each group. The foregoing multiple grouping manners are all sub-grouping methods for each group.

For the manner (1), the decoding end does not distinguish whether the current point is the duplicate point during grouping, and groups multiple points in the current group according to the preset grouping threshold. During grouping, after the number of points in a preceding sub-group reaches the preset grouping threshold, grouping is performed on a subsequent sub-group. To be specific, for each group, except for a last sub-group whose number of points is less than or equal to the preset grouping threshold, the number of points in other sub-groups is equal to the preset grouping threshold.

For example, for the color attribute, the preset grouping threshold may be a maximum transform order number colorMaxTransNum. For the reflectivity attribute, the preset grouping threshold may be a maximum transform order number refMaxTransNum.

The duplicate point is a point that is the same as any point in the current group or a point that is the same as any one of previous N points (for example, the previous 1 point). The current point is the duplicate point, namely, there is a point that is the same as the current point in the current group, or there is a point that is the same as the current point among the N points preceding to the current point. For example, when codes (such as geometrical codes or attribute codes) of two points are the same, it is determined that the two points are the same.

For the manner (2), the decoding end may consider whether the current point is the duplicate point during grouping. For a non-duplicate point, the grouping manner remains unchanged, and is basically similar to the manner (1). When the current point is the duplicate point, the current point may be first used to supplement the current sub-group. After the current sub-group is fully filled and reaches the preset grouping threshold, during subsequent grouping of duplicate points, each duplicate point may be independently divided into one sub-group. For example, the current group includes 10 points, the preset grouping threshold is 5, and after the grouping of the first sub-group is completed, there are two duplicate points in the remaining five points. In this case, when the duplicate points are grouped, the remaining two duplicate points are separately divided into two sub-groups.

For the manner (3), the decoding end may consider whether the current point is the duplicate point during grouping. For a non-duplicate point, the grouping manner remains unchanged, and is basically similar to the manner (1). When the current point is the duplicate point, the current point may be first used to supplement the current sub-group. After the current subgroup is fully filled and reaches the preset grouping threshold, the duplicate points may not be grouped subsequently. For example, there are 10 points in the current group, the preset grouping threshold is 5, and after the grouping of the first sub-group is completed, there are two duplicate points in the remaining 5 points. In this case, the two duplicate points are not grouped again.

For the manner (4), the decoding end may consider whether the current point is the duplicate point during grouping; for the non-duplicate point, the grouping manner remains unchanged, and is basically similar to the manner (1); when the current point is the duplicate point, the current point may not be used to supplement the current sub-group, but it is determined that the grouping of the current sub-group is completed; and regardless of whether the current sub-group reaches the preset grouping threshold, the grouping may be continued for a next sub-group, and the current point is put into the next sub-group; and if the next point is still a duplicate point, it is determined that the grouping of the next sub-group is completed, and then a grouping process of a next sub-group of the next sub-group is continued. This procedure repeats until all the current groups are grouped.

For the manner (5), the decoding end may consider whether the current point is the duplicate point during grouping. For a non-duplicate point, the grouping manner remains unchanged, and is basically similar to the manner (1). In response to that the current point is the duplicate point, the current point is not used to supplement the current sub-group, but it is determined that the grouping of the current sub-group is completed; regardless of whether the current sub-group reaches the preset grouping threshold, the grouping of a next sub-group may be continued, and during the subsequent grouping of duplicate points, each duplicate point may be independently divided into one sub-group.

For the manner (6), the decoding end may consider whether the current point is the duplicate point during grouping. For a non-duplicate point, the grouping manner remains unchanged, and is basically similar to the manner (1). In response to that the current point is the duplicate point, the current point is not used to supplement the current sub-group, but it is determined that the grouping of the current sub-group is completed; regardless of whether the current sub-group reaches the preset grouping threshold, the grouping of a next sub-group may be continued, and during the subsequent grouping, the remaining duplicate points may not be grouped.

For different grouping manners, the fourth indication parameter can provide decoding indication by setting different values. For example, the fourth indication parameter takes any integer from 1 to 6. The fourth indication parameter takes values from 1 to 6 and each value corresponds to a specific grouping manner (1) to (6). To be specific, if the fourth indication parameter is 1, the grouping manner is the manner (1).

In some embodiments, in response to that a to-be-decoded current sub-group includes the duplicate point, the decoding end determines the decoding manner of the current sub-group according to the fourth indication parameter.

Because the grouping manner may be set for the duplicate point, during decoding, the decoding end may alternatively determine the decoding manner corresponding to the sub-group for only the sub-group including the duplicate point. When it is determined that the to-be-decoded current sub-group includes the duplicate point, the decoding manner for decoding the current sub-group is determined according to the grouping manner obtained by parsing the fourth indication parameter.

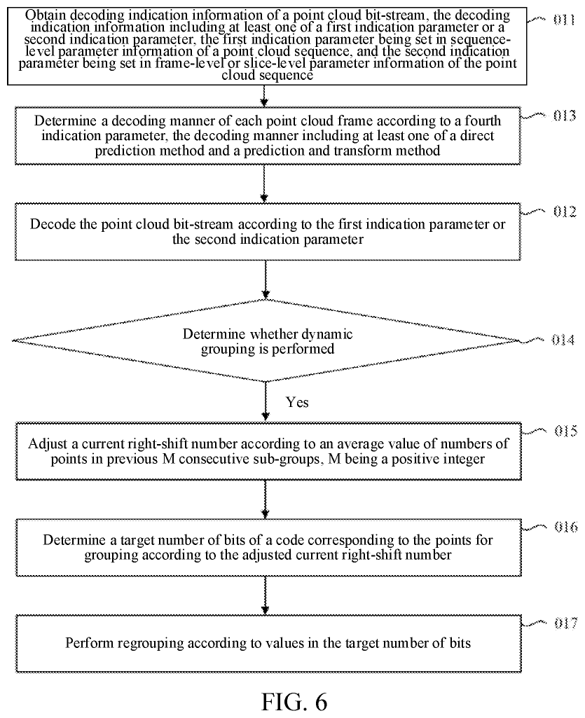

In some embodiments, referring to FIG. 6, grouping needs to be performed for both encoding and decoding, and a point cloud processing method includes:

Operation 014: A decoding end determines whether dynamic grouping is performed according to a related parameter of a quantization parameter of a point cloud frame or a maximum number of points in each sub-group.

Operation 015: If dynamic grouping is performed, the decoding end adjusts a current right-shift number according to an average value of the number of points in previous M consecutive sub-groups, M being a positive integer.

Operation 016: The decoding end determines a target number of bits of a code corresponding to a point for grouping according to the adjusted current right-shift number.

Operation 017: The decoding end performs regrouping according to values in the target number of bits.

Specifically, in the present disclosure, during grouping, the decoding end may perform dynamic grouping determination, to prevent the number of points in each group after grouping from deviating from an expected value, and affecting encoding/decoding performance.

Therefore, during grouping, the decoding end may determine whether to perform dynamic grouping according to the related parameter of the quantization parameter of the point cloud frame or the maximum number of points in each sub-group.

For example, the related parameter of the quantization parameter of the point cloud frame may include an initial offset shift; in response to that the initial offset is greater than 0, it is determined that dynamic grouping is performed; in response to that the initial offset is less than 0, it is determined that the dynamic grouping is not performed; or in response to that the initial offset is greater than 0, it is determined not to perform dynamic grouping, and in response to that the initial offset is greater than 0, it is determined that dynamic grouping is performed.

For another example, the decoding end statistically collects the maximum number of points in each sub-group in the point cloud frame, and determines whether the maximum number is greater than a preset number threshold. If the maximum number is greater than the preset threshold, it is determined that dynamic grouping is performed; and if the maximum number is less than or equal to the preset threshold, it is determined that the dynamic grouping is not performed. Alternatively, the decoding end determines whether the maximum number is less than the preset number threshold, determines that dynamic grouping is performed if the maximum number is less than the preset threshold, and determines that dynamic grouping is not performed if the maximum number is greater than or equal to the preset threshold.

In this way, in response to that the grouping fails to meet the expectation, the decoding end performs the dynamic grouping, to ensure that the grouping meets the expectation as much as possible.

When the dynamic grouping is performed, the decoding end may obtain an average value of numbers of points of previous M consecutive (such as first 8, 10, 15, and the like) sub-groups, and determines whether to adjust a current right-shift number for grouping through the average value. If the average value is less than 2, the current right-shift number is increased by 1, and in response to that the average value is greater than 8, the current right-shift number is decreased by 1, and then the points (such as the points in the point cloud frame) for grouping are grouped again based on the adjusted current right-shift number. Specifically, a target number of bits after a code of each point is right-shifted (for example, if the code is a 10-bit binary number, and the current right-shift number is 3, the remaining seven bits after the point is right-shifted by 3 are obtained as the target number of bits). The points with the same value formed by the target number of bits are divided into the same group, thereby obtaining a more balanced number of groups.

In some embodiments, the point cloud processing method further includes:

Operation 018: The decoding end determines that a predicted value of each attribute type of the current to-be-decoded point is a reconstructed value of each attribute type of a preceding point of the current to-be-decoded point in response to that the current to-be-decoded point is a duplicate point, and determines that a current residual value of the attribute type of the current to-be-decoded point is a non-negative number or a non-positive number.

Specifically, for the decoding of the duplicate point, when determining that the current to-be-decoded point is the duplicate point, the decoding end may determine the predicted value of each attribute type of the current to-be-decoded point according to the reconstructed value of each attribute type of the preceding point of the current to-be-decoded point. For example, the reconstructed value of each attribute type of the preceding point of the current to-be-decoded point is used as the predicted value of each corresponding attribute type of the current to-be-decoded point, thereby enabling quick decoding to obtain the predicted value of the current to-be-decoded point.

For a reflectivity attribute, in response to that the current to-be-decoded point is the duplicate point, the decoding end determines that the predicted value of the reflectivity attribute of the current to-be-decoded point is a reconstructed value of the reflectivity attribute of the preceding point of the current to-be-decoded point, and determines that a sign bit of the current residual value of the reflectivity attribute of the current to-be-decoded point is a non-negative number or a non-positive number.

For a color attribute, in response to that the current to-be-decoded point is the duplicate point, the decoding end determines that a predicted value of a K^{th} component of the color attribute of the current to-be-decoded point is a reconstructed value of the K^{th} component of the preceding point of the current to-be-decoded point, and determines that the K^{th} component of a current residual value of the color attribute of the current to-be-decoded point is a non-negative number or a non-positive number, K being any integer of 1 to 3. Alternatively, in response to that the current to-be-decoded point is the duplicate point, the decoding end determines that a predicted value of each component of the color attribute of the current to-be-decoded point is a reconstructed value of each component of the preceding point of the current to-be-decoded point, and each component of the current residual value of the color attribute of the current to-be-decoded point is a non-negative number or a non-positive number.

During encoding, a residual value of the duplicate point is correspondingly processed, so that the sign bit of the duplicate point does not need to be identified in a decoding process. During encoding, the residual value of the duplicate point is processed in one of the following manners:
(1) In response to that the residual value of the duplicate point is a negative number, the residual value of the duplicate point is set to 0;
(2) for the color attribute, in response to that the K^{th} component of the residual value of the duplicate point is a negative number, the K^{th} component is set to 0; and
(3) for the color attribute, in response to that any component of the residual value of the duplicate point is a negative number, the component is set to 0.

In this case, for the situation (1), for the color attribute or the reflectivity attribute, when decoding the to-be-decoded point that is a duplicate point, the decoding end may directly determine a residual value of the to-be-decoded point to be a non-negative number for decoding without identifying a sign bit. For the situation (2), for the color attribute, when decoding the color attribute of the to-be-decoded point that is the duplicate point, the decoding end may directly determine the K^{th} component of the residual value of the to-be-decoded point to be a non-negative number for decoding without identifying the sign bit of the K^{th} component of the residual value. For the situation (3), for the color attribute, when decoding the color attribute of the to-be-decoded point that is the duplicate point, the decoding end may directly determine each component of the residual value of the to-be-decoded point to be a non-negative number for decoding without identifying the sign bit of any component of the residual value.

During encoding, the residual value of the duplicate point may be further processed in one of the following manners:
(1) In response to that the residual value of the duplicate point is a positive number, the residual value of the duplicate point is set to 0;
(2) for the color attribute, in response to that the K^{th} component of the residual value of the duplicate point is a positive number, the K^{th} component is set to 0; and
(3) for the color attribute, in response to that any component of the residual value of the duplicate point is a positive number, the component is set to 0.

In this case, for the situation (1), for the color attribute or the reflectivity attribute, when decoding the to-be-decoded point that is the duplicate point, the decoding end may directly determine the residual value of the to-be-decoded point to be a non-positive number for decoding without identifying the sign bit. For the situation (2), for the color attribute, when decoding the color attribute of the to-be-decoded point that is the duplicate point, the decoding end may directly determine the K^{th} component of the residual value of the to-be-decoded point to be a non-positive number for decoding without identifying the sign bit of the K^{th} component of the residual value. For the situation (3), for the color attribute, when decoding the color attribute of the to-be-decoded point that is the duplicate point, the decoding end may directly determine each component of the residual value of the to-be-decoded point to be a non-positive number for decoding without identifying the sign bit of any component of the residual value.

In the following examples of Table 10 and Table 11, the foregoing method for processing a residual value of a color attribute of a duplicate point may be defined in color attribute data.

TABLE 10

| | Descriptor |
|---|---|
| color_residual_correlation_code( ) { | |
| color_first_comp_zero | ae(v) |
| if (!color_first_comp_zero) { | |
| color_component[0] = color_component_code(true) | |
| color_component[1] = color_component_code(false) | |
| color_component[2] = color_component_code(false) | |
| if(!isDuplicatePoint) | |
| color_component_sign[0] | ae (1) |
| if(color_component[1]!=0) | |
| color_component_sign[1] | ae (1) |
| if(color_component[2]!=0) | |
| color_component_sign[2] | ae (1) |
| } else { | |
| color_component[0] = 0 | |
| color_second_comp_zero | ae(v) |
| if (!color_second_comp_zero) { | |
| color_component[1] = color_component_code(true) | |
| color_component[2] = color_component_code(false) | |
| if(!isDuplicatePoint) | |
| color_component_sign[1] | ae (1) |
| if(color_component[2]!=0) | |
| color_component_sign[2] | ae (1) |
| else { | |
| color_component[1] = 0 | |
| color_component[2] = color_component_code(true) | |
| color_component_sign[2] | ae (1) |
| } | |
| } | |
| } | |

TABLE 11

| | Descriptor |
|---|---|
| color_residual_correlation_code( ) { | |
| color_first_comp_zero | ae(v) |
| if (!color_first_comp_zero) { | |
| color_component[0] = color_component_code(true) | |
| color_component[1] = color_component_code(false) | |
| color_component[2] = color_component_code(false) | |
| if(!(isDuplicatePoint && orderSwitch==0)) | |
| color_component_sign[0] | ae (1) |
| if(color_component[1]!=0 && !(isDuplicatePoint && | |
| orderSwitch==1)) | |
| color_component_sign[1] | ae (1) |
| if(color_component[2]!=0) | |
| color_component_sign[2] | ae (1) |
| } else { | |
| color_component[0] = 0 | |
| color_second_comp_zero | ae(v) |
| If (!color_second_comp_zero) { | |
| color_component[1] = color_component_code(true) | |
| color_component[2] = color_component_code(false) | |
| if(!(isDuplicatePoint && orderSwitch==1)) | |
| color_component_sign[1] | ae (1) |
| if(color_component[2]!=0) | |
| color_component_sign[2] | ae (1) |
| else { | |
| color_component[1] = 0 | |
| color_component[2] = color_component_code(true) | |
| color_component_sign[2] | ae (1) |
| } | |
| } | |
| } | |

Semantic descriptions are provided below for syntactic elements in Table 10 and Table 11.

Zero flag for color first component residual value (color first comp zero): a binary variable. A value of 1′ indicates that the residual value of a color first component is 0; and a value of ‘0’ indicates that the residual value of the color first component is not 0. When orderSwitch=0, the color first component is Y (a color space is YUV) or R (the color space is RGB); and otherwise, the color first component is U (the color space is YUV) or G (the color space is RGB).

Zero flag for color second component residual value (color_second_comp_zero): a binary variable. A value of ‘1’ indicates that a residual value of a color second component is 0; and a value of ‘0’ indicates that the residual value of the color second component is not 0. When orderSwitch=0, the color second component is U (the color space is YUV) or G (the color space is RGB); and otherwise, the color second component is Y (the color space is YUV) or R (the color space is RGB).

Color residual component (color component [k]): a binary variable. A value of ‘1’ indicates that the residual value of the color first component is positive; and a value of ‘0’ indicates that the residual value of the color first component is negative. k=0, 1, 2.

Color residual component sign (color_component_sign [k]): a binary variable. A value of ‘1’ indicates that the residual value of the color first component is positive; and a value of ‘0’ indicates that the residual value of the color first component is negative. k=0, 1, 2.

Residual encoding order switch (orderSwitch): a binary variable. A value of 1′ indicates that a residual encoding order is a UYV/GSB order; and a value of ‘0’ indicates that the residual encoding order is a YUV/RGB order.

Duplicate point flag field (isDuplicatePoint): this field indicates whether a current point is a duplicate point, a value of “true” indicates that the current point is a duplicate point, and a value of “false” indicates that the current point is not a duplicate point.

In some embodiments, the color attribute is represented by using an RGB encoding format or a YUV encoding format, where the RGB encoding format includes three components, namely, R, G, and B, or the YUV encoding format includes three components, namely, Y, U, and V, and the K^{th} component is any one of the R, G, and B components or any one of the Y, U, and V components.

Specifically, both the RGB and YUV are the color encoding formats. The R component in the RGB encoding format represents a red component, the G component represents a green component, and the B component represents a blue component. The Y component in the YUV encoding format represents a luminosity component, and the U component and the V component represent a chrominance.

When the color attribute is represented by using the RGB encoding format, the K^{th} component is any one of the R, G, and B components; and when the color attribute is represented by using the YUV encoding format, the K^{th} component is any one of the Y, U, and V components, thereby quickly determining the K^{th} component of the residual value of the to-be-decoded point.

In some embodiments, the decoding indication information further includes a fifth indication parameter, the fifth indication parameter is set in the sequence header, a value of the fifth indication parameter includes any one of a plurality of preset values, and when the fifth indication parameter takes different preset values, the fifth indication parameter corresponds to different decoding frame rates.

Specifically, during actual decoding, the decoding end usually supports only one or more decoding frame rates. Therefore, to provide decoding indication, the fifth indication parameter may be set in the sequence header, to indicate the decoding frame rate. When the fifth indication parameter takes different preset values, the fifth indication parameter corresponds to one of a plurality of decoding frame rates supported by the decoding end. A sequence header in which the fifth indication parameter is set is shown in Table 12.

TABLE 12

| | Descriptor |
|---|---|
| sequence_header( ) { | |
| profile_id | u(4) |
| level_id | u(8) |
| frameRateCode | u(4) |
| marker_bit | f(1) |
| ... | |
| byte_alignment( ) | |
| } | |

The fifth indication parameter is frameRateCode, which is a 4-bit unsigned integer, and is configured for specifying a frame rate.

A mapping relationship between the frame rate and a value of the fifth indication parameter is shown in Table 13.

TABLE 13

| Value of frame rate code | Frame rate |
|---|---|
| 0000 | Forbidden |
| 0001 | 10 |
| 0010 | 20 |
| 0011 | 30 |
| 0100 | 60 |
| 0101-1111 | Reserved |

Table 13 is merely an example of the mapping relationship between the value of the fifth indication parameter and the frame rate, and is not used as a limitation to the value of the fifth indication parameter.

In some embodiments, the attribute header includes an attribute quantization parameter field, the attribute quantization parameter field is configured for controlling an attribute quantization parameter of the point cloud, and the attribute quantization parameter is configured for providing attribute decoding indication for attribute quantization of the point cloud frame.

Specifically, by setting the attribute quantization parameter in the attribute header, the attribute quantization parameter of each attribute type may be defined. Specifically, the attribute header in which the attribute quantization parameter is defined is shown in Table 14 below.

TABLE 14

| | Descriptor |
|---|---|
| attribute_header( ) { | |
| for ( attrIdx = 0; attrIdx < (maxNumAttributesMinus1 + 1); attrIdx ++ ){ | |
| attributePresentFlag[attrIdx] | u(1) |
| if(attributePresentFlag[attrIdx]){ | |
| attribute_data_num_set_minus1[attrIdx] | ue(v) |
| attributeQuantParam[attrIdx] | ue(v) |
| if((attrIdx == 1) && (attribute_data_num_set_minus1[1]>0)){ | |
| for(i=0;i< ((attribute_data_num_set_minus1 [1]+1); i++){ | |
| multi_attr_group_id [i] | ue(v) |
| } | |
| } | |
| if(sps_multi_set_flag) | |
| multi_set_flag[attrIdx] | u(1) |
| if(multi_set_flag[attrIdx]) | |
| attribute_info_num_set_minus1[attrIdx] | ue(v) |
| for(i=0;i< (attribute_info_num_set_minus1[attrIdx]+1); i++){ | |
| outputBitDepthMinus1[attrIdx][i] | ue(v) |
| ... | |
| } | |
| } | |
| } | |

An attribute quantization parameter field is attributeQuantParam[attrIdx]. For other syntactic elements in the foregoing table, specifically refer to the descriptions in Table 4, and details are not described herein again.

In some embodiments, the attribute header includes a plurality of attribute types, each attribute type has an attribute quantization parameter field, the attribute quantization parameter field under a target attribute type is configured for controlling the attribute quantization parameter of the point cloud under the target attribute type, the attribute quantization parameter under the target attribute type is configured for providing attribute decoding indication for attribute quantization of the point cloud frame under the target attribute type, and the target attribute type is any one of a plurality of attribute types.

Specifically, in response to that there are a plurality of attribute types, the attribute quantization parameter corresponding to each attribute type may be defined. Specifically, as shown in Table 15 below, the attribute header of the corresponding attribute quantization parameter is defined for each attribute type.

TABLE 15

| | Descriptor |
|---|---|
| attribute_header( ) { | |
| for ( attrIdx = 0; attrIdx < (maxNumAttributesMinus1 + 1); attrIdx ++ ){ | |
| attributePresentFlag[attrIdx] | u(1) |
| if(attributePresentFlag[attrIdx]){ | |
| attribute_data_num_set_minus1[attrIdx] | ue(v) |
| if((attrIdx == 1) && (attribute_data_num_set_minus1[1]>0)){ | |
| for(i=0;i< ((attribute_data_num_set_minus1[1]+1); i++){ | |
| multi_attr_group_id [i] | ue(v) |
| } | |
| } | |
| if(sps_multi_set_flag) | |
| multi_set_flag[attrIdx] | u(1) |
| if(multi_set_flag[attrIdx]) | |
| attribute_info_num_set_minus1[attrIdx] | ue(v) |
| for(i=0;i< (attribute_info_num_set_minus1[attrIdx]+1); i++){ | |
| attributeQuantParam[attrIdx][i] | ue(v) |
| outputBitDepthMinus1[attrIdx][i] | ue(v) |
| ... | |
| } | |
| } | |
| } | |

The attribute quantization parameter is defined in a loop statement based on a field (attribute_info_num_set_minus1[attrIdx]) of attribute information number minus one. Different attribute quantization parameters may be set for each attribute type, and the attribute quantization parameter corresponding to each attribute type is parsed by using the loop statement.

Besides the definition of the attribute quantization parameter, a corresponding attribute quantization parameter offset may be further defined for each attribute type. Specifically, the attribute header in which the attribute quantization parameter offset corresponding to each attribute type is set as shown in Table 16 or 17 below.

TABLE 16

| | Descriptor |
|---|---|
| attribute_header( ) { | |
| for ( attrIdx = 0; attrIdx < (maxNumAttributesMinus1 + 1); attrIdx ++ ){ | |
| attributePresentFlag[attrIdx] | u(1) |
| if(attributePresentFlag[attrIdx]){ | |
| attribute_data_num_set_minus1[attrIdx] | ue(v) |
| attributeQuantParam[attrIdx] | ue(v) |
| if((attrIdx == 1) && (attribute_data_num_set_minus1[1]>0)){ | |
| for(i=0;i< ((attribute_data_num_set_minus1 [1]+1); i++){ | |
| multi_attr_group_id [i] | ue(v) |
| } | |
| } | |
| if(sps_multi_set_flag) | |
| multi_set_flag[attrIdx] | u(1) |
| if(multi_set_flag[attrIdx]) | |
| attribute_info_num_set_minus1[attrIdx] | ue(v) |
| for(i=0;i< (attribute_info_num_set_minus1[attrIdx]+1); i++){ | |
| attributeQuantParamOffset[attrIdx][i] | ue(v) |
| outputBitDepthMinus1[attrIdx][i] | ue(v) |
| ... | |
| } | |
| } | |
| } | |

The corresponding attribute quantization parameter offset (attributeQuantParamOffset[attrIdx][i]) is defined for each attribute type in Table 16.

TABLE 17

| | Descriptor |
|---|---|
| attribute_header( ) { | |
| for ( attrIdx = 0; attrIdx < (maxNumAttributesMinus1 + 1); attrIdx ++ ){ | |
| attributePresentFlag[attrIdx] | u(1) |
| if(attributePresentFlag[attrIdx]){ | |
| attribute_data_num_set_minus1[attrIdx] | ue(v) |
| attributeQuantParam[attrIdx] | ue(v) |
| if((attrIdx == 1) && (attribute_data_num_set_minus1[1]>0)){ | |
| for(i=0;i< ((attribute_data_num_set_minus1 [1]+1); i++){ | |
| multi_attr_group_id [i] | ue(v) |
| } | |
| } | |
| if(sps_multi_set_flag) | |
| multi_set_flag[attrIdx] | u(1) |
| if(multi_set_flag[attrIdx]) | |
| attribute_info_num_set_minus1[attrIdx] | ue(v) |
| for(i=0;i< (attribute_info_num_set_minus1[attrIdx]+1); i++){ | |
| outputBitDepthMinus1[attrIdx][i] | ue(v) |
| if (attrIdx == 0) { | |
| colorQuantParamOffset[i] | ue(v) |
| ... | |
| } | |
| if (attrIdx == 1) { | |
| reflQuantParamOffset[i] | ue(v) |
| ... | |
| } | |
| ... | |
| } | |
| } | |
| } | |

In table 17, for each attribute type, a corresponding color attribute quantization parameter offset (colorQuantParamOffset[i]) and a reflectivity attribute quantization parameter offset (reflQuantParamOffset[i]) are defined respectively for the color attribute and the reflectivity attribute.

For explanations of the syntactic elements in Table 16 and Table 17, refer to the descriptions in Table 4, and details are not described herein again.

In some embodiments, when the target attribute type is a reflectivity attribute, the attribute quantization parameter field under the target attribute type includes at least one of the reflectivity attribute quantization parameter and the reflectivity attribute quantization parameter offset; and when the target attribute type is a color attribute, the attribute quantization parameter field under the target attribute type includes any one of the following: a color attribute quantization parameter and an attribute quantization parameter offset of each color component.

In some embodiments, a slice header includes an attribute slice header, and the decoding indication information further includes an attribute quantization parameter field set in the attribute slice header.

Specifically, when the attribute quantization parameter field is defined, besides being defined in the attribute header, the attribute quantization parameter field may further be defined in the attribute slice header, so that each attribute slice has the corresponding attribute quantization parameter. During decoding, the attribute quantization parameter corresponding to each attribute slice is parsed, to implement slice-level attribute quantization control.

The attribute slice header in which the attribute quantization parameter field is defined is shown in table 18.

TABLE 18

| | Descriptor |
|---|---|
| attribute_slice_header( ) { | |
| attribute_slice_header_start_code | f(32) |
| slice_id | ue(v) |
| attributeID | ue(v) |
| reflQPoffset | se(v) |
| byte_alignment( ) | |
| } | |

where reflQPoffset is a reflectivity attribute quantization parameter offset. When the attribute type of the attribute quantization parameter field is a reflectivity attribute, the attribute quantization parameter field may include at least one of the reflectivity attribute quantization parameter and the reflectivity attribute quantization parameter offset; and when the attribute type of the attribute quantization parameter field is a color attribute, the attribute quantization parameter field includes any one of the following: the color attribute quantization parameter and the attribute quantization parameter offset of each color component.

In some embodiments, the decoding indication information includes a loop statement set in a point cloud sequence, the point cloud frame includes a point cloud slice, the point cloud slice includes an attribute slice, the attribute slice is located in the loop statement, the attribute slice includes an attribute slice header and an attribute data bit-stream, and the loop statement traverses all attribute slices by using an attribute slice header start code.

Specifically, to implement traversing and parsing for a plurality of attribute slices, the decoding indication information may further include the loop statement set in the point cloud sequence; and the attribute slice is set in the loop statement, and then the loop statement sequentially traverses and parses the attribute slices by using attribute slice start codes, to ensure that all the attribute slices can be parsed.

As shown in Table 19, the point cloud sequence of the loop statement is defined.

TABLE 19

Descriptor

```
PCC_sequence( ) {
  do {
      sequence_header( )
      geometry_header( )
      if (attribute_present_flag) {
        attribute_header( )
      }
      if (next_bits(32) == user_data_start_code)
          userdata_bitstream ( )
      do{
          frame_header( )
          if (next_bits(32) == user_data_start_code)
              userdata_bitstream ( )
          do {
            geometry_slice( )
            if (attribute_present_flag) {
                do{
                  attribute_slice( )
```

| | |
|---|---|
| } | while(next_bits(32) == |

```
attribute_slice_header_start_code)
          }while(next_bits(32) == gometry_slice_header_start_code)
    }while(next_bits(32) == frame_start_code)
  } while (next_bits(32) != sequence_end_code))
}
```

The loop statement, such as a loop in which an attribute slice (attribute_slice( )) in Table 19 is located, performs the loop traversing by using the attribute slice header start code (attribute_slice_header_start_code), to traverse each attribute slice.

In some embodiments, the point cloud frame includes a point cloud slice, the point cloud slice includes an attribute slice, the decoding indication information includes a loop statement set in the attribute slice, and the attribute slice includes an attribute slice header and an attribute data bit-stream.

The attribute slice header and the attribute data bit-stream are both located in the loop statement. The loop statement traverses the attribute slice headers and attribute data bit-streams by using the attribute slice start code, and the attribute slice headers are in one-to-one correspondence with the attribute data bit-streams.

Specifically, the loop statement may be further defined in the attribute slice, the attribute slice header and the attribute data bit-stream of the attribute slice are defined into the loop statement, and the loop statement is enabled to traverse the attribute slice headers and the attribute data bit-streams by using the attribute slice start code, thereby implementing the traversing and parsing for the attribute slice headers and the attribute data bit-streams of the attribute slices.

The attribute slice in which a loop statement is defined is shown in Table 20 below.

TABLE 20

Descriptor

```
attribute_slice( ) {
do{
      attribute_slice_header( )
    general_attribute_data_bitstream( )
  } while(next_start_code == attribute_slice_header_start_code)
}
```

The loop statement in which the attribute slice headers (attribute_slice_header( )) and the attribute data bit-streams (general_attribute_data_bitstream( )) are located performs traversing and parsing according to the attribute slice header start code.

Alternatively, the attribute data bit-streams are located in the loop statement, and the attribute slice header is set outside the loop statement, so that the attribute slice header can correspond to one or more attribute data bit-streams, and the loop statement traverses each of the attribute data bit-streams by using the attribute data start code.

The attribute slice in which the loop statement is defined is shown in Table 21.

TABLE 21

Descriptor

```
attribute_slice( ) {
  attribute_slice_header( )
  do{
    general_attribute_data_bitstream( )
  } while(next_start_code == attribute_slice_payload_start_code)
}
```

The attribute slice header (attribute_slice_header( )) is located outside the loop statement, and the attribute data bit-streams (general_attribute_data_bitstream( )) are located inside the loop statement; and the traversing is performed according to the attribute data start code, and one or more attribute data bit-streams corresponding to the attribute slice header are parsed.

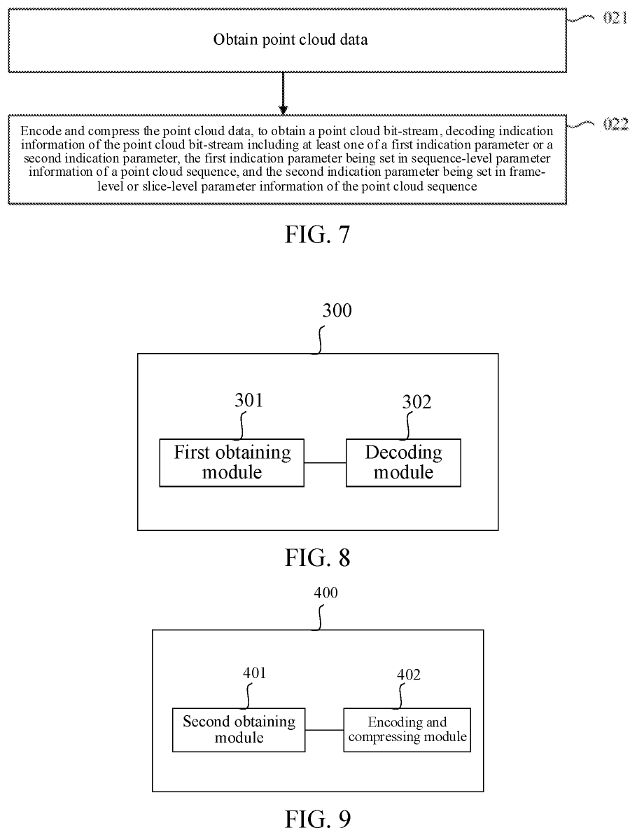

According to the method described in the foregoing embodiments, an embodiment of the present disclosure further provides another point cloud processing method. FIG. 7 is a schematic flowchart of another point cloud processing method according to an embodiment of the present disclosure. The point cloud processing method may be applied to an encoding device. In some embodiments, the encoding device may be a content producing device. The point cloud processing method specifically includes:

Operation 021: An encoding end obtains point cloud data.

Operation 022: The encoding end encodes and compresses the point cloud data, to obtain a point cloud bit-stream, decoding indication information of the point cloud bit-stream including at least one of a first indication parameter or a second indication parameter, the first indication parameter being set in sequence-level parameter information of a point cloud sequence, the second indication parameter being set in frame-level or slice-level parameter information of the point cloud sequence, the first indication parameter providing sequence-level decoding indication, the second indication parameter providing frame-level or slice-level decoding indication, and the point cloud bit-stream being decoded according to the first indication parameter or the second indication parameter.

In some embodiments, the sequence header further includes a third indication parameter, and in response to that a value of the third indication parameter is a first preset value, each point cloud frame of the point cloud sequence is encoded according to the first indication parameter. In response to that the value of the third indication parameter is a second preset value, each point cloud frame is encoded according to the second indication parameter of each point cloud frame, and the first present value and the second preset value are different.

In some embodiments, the first indication parameter and the second indication parameter each includes at least one of a bounding box origin coordinate field, a bounding box size field, and a quantization parameter field.

In some embodiments, the first indication parameter is determined according to the second indication parameter of each point cloud frame. Alternatively, the first indication parameter is a preset value.

In some embodiments, the decoding indication information further includes a fourth indication parameter, and the fourth indication parameter is configured for indicating a grouping manner of each point cloud frame.

In some embodiments, a grouping manner includes at least one of the following manners:
dividing points in each group into a plurality of sub-groups according to a preset grouping threshold, and performing grouping for a latter sub-group after a number of points of a preceding sub-group reaches the preset grouping threshold;
supplementing a current sub-group with a current point in response to that the current point for grouping is a duplicate point, and dividing each of the remaining duplicate points into a separate sub-group until the number of the points of the current sub-group reaches the preset grouping threshold, where the duplicate point is a point that is the same as any point in the group to which the point belongs or as any point among previous N points, and N is a positive integer;
supplementing the current sub-group with the current point in response to that the current point for grouping is the duplicate point, and stopping continuous grouping for the remaining duplicate points until the number of points in the current sub-group reaches the preset grouping threshold;
determining, in response to that the current point for grouping is the duplicate point, that grouping for the current sub-group is completed, and continuing grouping for the remaining points according to the preset grouping threshold;
determining, in response to that the current point for grouping is the duplicate point, that grouping for the current sub-group is completed, and dividing each of the remaining duplicate points into a separate sub-group; and
determining, in response to that the current point for grouping is the duplicate point, that grouping for the current sub-group is completed, and stopping continuous grouping for the remaining duplicate points.

In some embodiments, whether dynamic grouping is performed is determined according to a related parameter of a quantization parameter of a point cloud frame or a maximum number of points in each sub-group; if dynamic grouping is performed, a current right-shift number is adjusted according to an average value of the numbers of points in previous M consecutive sub-groups, M being a positive integer; a target number of bits of a code corresponding to the points for grouping is determined according to the adjusted current right-shift number; and grouping is performed again according to values in the target number of bits.

In some embodiments, the sequence header further includes a fifth indication parameter, a value of the fifth indication parameter includes any one of a plurality of preset values, and when the fifth indication parameter takes different preset values, the fifth indication parameter corresponds to different decoding frame rates.

In some embodiments, the decoding indication information further includes an attribute header set in the point cloud frame, the attribute header includes an attribute quantization parameter field, the attribute quantization parameter field is configured for controlling an attribute quantization parameter of the point cloud, and the attribute quantization parameter is configured for providing attribute encoding indication for attribute quantization of the point cloud frame.

In some embodiments, the attribute header includes a plurality of attribute types, each attribute type has an attribute quantization parameter field, the attribute quantization parameter field under a target attribute type is configured for controlling the attribute quantization parameter of the point cloud under the target attribute type, the attribute quantization parameter under the target attribute type is configured for providing attribute encoding indication for attribute quantization of the point cloud frame under the target attribute type, and the target attribute type is any one of a plurality of attribute types.

In some embodiments, a slice header includes an attribute slice header, and the decoding indication information further includes an attribute quantization parameter field set in the attribute slice header.

In some embodiments, when the attribute type of the attribute quantization parameter field is a reflectivity attribute, the attribute quantization parameter field includes at least one of a reflectivity attribute quantization parameter and a reflectivity attribute quantization parameter offset; and when the attribute type of the attribute quantization parameter field is a color attribute, the attribute quantization parameter field includes any one of the following: a color attribute quantization parameter and an attribute quantization parameter offset of each color component.

In some embodiments, the decoding indication information includes a loop statement set in a point cloud sequence, the point cloud frame includes a point cloud slice, the point cloud slice includes an attribute slice, the attribute slice is located in the loop statement, and the loop statement traverses all attribute slices by using an attribute slice header start code.

In some embodiments, the point cloud slice includes an attribute slice, the decoding indication information includes a loop statement set in the attribute slice, and the attribute slice includes an attribute slice header and an attribute data bit-stream;

the attribute slice header and the attribute data bit-stream are both located in the loop statement. The loop statement traverses the attribute slice headers and the attribute data bit-streams by using the attribute slice start code, and the attribute slice headers are in one-to-one correspondence with the attribute data bit-streams; or

the attribute data bit-streams are located in the loop statement, the loop statement traverses the attribute data bit-streams by using an attribute data start code, and the attribute slice header corresponds to one or more attribute data bit-streams.

The encoding process and the decoding process of the point cloud are reversible. Therefore, in the point cloud processing method applied to a content producing device according to an embodiment of the present disclosure, for the syntactic definitions involved, refer to the embodiments of the point cloud processing method applied to the content presentation device described above, and details are not described again herein.

According to the method described in the foregoing embodiments, an embodiment of the present disclosure further provides a point cloud processing apparatus, configured to perform operations in the foregoing point cloud processing method applied to the content presentation device. FIG. 8 is a schematic structural diagram of a point cloud processing apparatus according to an embodiment of the present disclosure. The point cloud processing apparatus 300 is applied to a decoding device. In some embodiments, the decoding device may be a content display device, and includes a first obtaining module 301 and a decoding module 302.

The first obtaining module 301 is configured to obtain decoding indication information of a point cloud bit-stream, the decoding indication information including at least one of a first indication parameter or a second indication parameter, the first indication parameter being set in sequence-level parameter information of a point cloud sequence, the second indication parameter being set in frame-level or slice-level parameter information of the point cloud sequence, the first indication parameter providing sequence-level decoding indication, and the second indication parameter providing frame-level or slice-level decoding indication; and

the decoding module 302 is configured to decode the point cloud bit-stream according to the first indication parameter or the second indication parameter.

In some embodiments, the sequence-level parameter information includes a sequence header, the sequence header further includes a third indication parameter, and the third indication parameter indicates whether the decoding of the point cloud bit-stream is performed according to the first indication parameter or the second indication parameter; and the decoding module 302 is specifically configured to decode each point cloud frame of the point cloud sequence according to the first indication parameter in response to that a value of the third indication parameter is a first preset value, and decode each point cloud frame according to the second indication parameter of each point cloud frame in response to that the value of the third indicator parameter is a second preset value, and the first preset value and the second preset value are different.

In some embodiments, the first indication parameter and the second indication parameter each includes at least one of a bounding box origin coordinate field, a bounding box size field, and a quantization parameter field.

In some embodiments, the first indication parameter is determined according to the second indication parameter of each point cloud frame of the point cloud sequence; or the first indication parameter is a preset value.

In some embodiments, the decoding indication information further includes a fourth indication parameter, the fourth indication parameter is configured for indicating a grouping manner of the point cloud frames of the point cloud sequence; and the decoding module 302 is further configured to determine a decoding manner of the point cloud frames according to the fourth indication parameter, and the decoding manner includes at least one of a direct prediction method and a prediction and transform method.

In some embodiments, the grouping manner includes at least one of the following:
dividing points in each group into a plurality of sub-groups according to a preset grouping threshold, and performing grouping for a latter sub-group after a number of points of a preceding sub-group reaches the preset grouping threshold;
supplementing a current sub-group with a current point in response to that the current point for grouping is a duplicate point, and dividing each of the remaining duplicate points into a separate sub-group until the number of points of the current sub-group reaches the preset grouping threshold, where the duplicate point is a point that is the same as any point in the group to which the point belongs or as any point among previous N points, and N is a positive integer;
supplementing the current sub-group with the current point in response to that the current point for grouping is the duplicate point, and stopping continuous grouping for the remaining duplicate points until the number of points in the current sub-group reaches the preset grouping threshold;
determining, in response to that the current point for grouping is the duplicate point, that grouping for the current sub-group is completed, and continuing grouping for the remaining points according to the preset grouping threshold;
determining, in response to that the current point for grouping is the duplicate point, that grouping for the current sub-group is completed, and dividing each of the remaining duplicate points into a separate sub-group; and
determining, in response to that the current point for grouping is the duplicate point, that grouping for the current sub-group is completed, and stopping continuous grouping for the remaining duplicate points.

In some embodiments, the decoding module 302 is specifically configured to determine a decoding manner of the current sub-group according to the fourth indication parameter in response to that a to-be-decoded current sub-group includes a duplicate point.

In some embodiments, the decoding module 302 is further configured to determine whether dynamic grouping is performed according to a related parameter of a quantization parameter of the point cloud frame or a maximum number of points in each sub-group; adjust a current right-shift number according to an average value of numbers of points in previous M consecutive sub-groups if dynamic grouping is performed, M being a positive integer; determine a target number of bits of a code corresponding to the point for grouping according to the adjusted current right-shift number; and perform grouping again according to a value in the target number of bits.

In some embodiments, the decoding module 302 is further configured to determine that a predicted value of each attribute type of the current to-be-decoded point is a reconstructed value of each attribute type of a preceding point of the current to-be-decoded point in response to that the current to-be-decoded point is a duplicate point, and determine that a current residual value of the attribute type of the current to-be-decoded point is a non-negative number or a non-positive number.

In some embodiments, the attribute type includes a color attribute, and the decoding module 302 is further configured to determine that a predicted value of a K^{th} component of the color attribute of the current to-be-decoded point is a reconstructed value of the K^{th} component of the preceding point of the current to-be-decoded point in response to that the current to-be-decoded point is the duplicate point, and determine that the K^{th} component of the current residual value of the color attribute of the current to-be-decoded point is a non-negative number or a non-positive number, K being any integer of 1 to 3; or the decoding module is configured to determine that a predicted value of each component of the color attribute of the current to-be-decoded point is a reconstructed value of each component of the preceding point of the current to-be-decoded point in response to that the current to-be-decoded point is the duplicate point, and determine that each component of the current residual value of the color attribute of the current to-be-decoded point is a non-negative number or a non-positive number.

In some embodiments, the color attribute is represented by using an RGB encoding format or a YUV encoding format, where the RGB encoding format includes three components, namely, R, G, and B, or the YUV encoding format includes three components, namely, Y, U, and V, and the K^{th} component is any one of the R, G, and B components or any one of the Y, U, and V components.

In some embodiments, the decoding module 302 is further configured to determine that a predicted value of a reflectivity attribute of the current to-be-decoded point is a reconstructed value of the reflectivity attribute of a preceding point of the current to-be-decoded point in response to that the current to-be-decoded point is the duplicate point, and determine that a sign bit of a current residual value of the reflectivity attribute of the current to-be-decoded point is a non-negative number or a non-positive number.

In some embodiments, the sequence-level parameter information includes a sequence header, the decoding indication information further includes a fifth indication parameter, the fifth indication parameter is configured for indicating a decoding frame rate, the fifth indication parameter is set in the sequence header, a value of the fifth indication parameter includes any one of a plurality of preset values, and when the fifth indication parameter takes different preset values, the fifth indication parameter corresponds to different decoding frame rates.

In some embodiments, the decoding indication information further includes an attribute header set in the point cloud frame, the attribute header includes an attribute quantization parameter field, the attribute quantization parameter field is configured for controlling an attribute quantization parameter of the point cloud, and the attribute quantization parameter is configured for providing attribute decoding indication for attribute quantization of the point cloud frame.

In some embodiments, the attribute header includes a plurality of attribute types, each attribute type has an attribute quantization parameter field, the attribute quantization parameter field under a target attribute type is configured for controlling the attribute quantization parameter of the point cloud under the target attribute type, the attribute quantization parameter under the target attribute type is configured for providing attribute decoding indication for attribute quantization of the point cloud frame under the target attribute type, and the target attribute type is any one of a plurality of attribute types.

In some embodiments, the point cloud sequence includes a point cloud frame, the point cloud frame includes a point cloud slice, the point cloud slice includes an attribute slice header, and the decoding indication information further includes an attribute quantization parameter field set in the attribute slice header.

In some embodiments, when the attribute type of the attribute quantization parameter field is a reflectivity attribute, the attribute quantization parameter field may include at least one of a reflectivity attribute quantization parameter and a reflectivity attribute quantization parameter offset; and when the attribute type of the attribute quantization parameter field is a color attribute, the attribute quantization parameter field includes any one of the following: a color attribute quantization parameter and an attribute quantization parameter offset of each color component.

In some embodiments, the decoding indication information includes a loop statement set in the point cloud sequence, the point cloud sequence includes a point cloud frame, the point cloud frame includes a point cloud slice, the point cloud slice includes attribute slices, the attribute slices are located in the loop statement, and the loop statement traverses all attribute slices by using an attribute slice start code.

In some embodiments, the point cloud sequence includes a point cloud frame, the point cloud frame includes point cloud slices, the point cloud slices include attribute slices, the decoding indication information includes a loop statement set in the attribute slice, the attribute slice includes an attribute slice header and an attribute data bit-stream, the attribute slice header and the attribute data bit-stream are both located in the loop statement, the loop statement traverses the attribute slice headers and the attribute data bit-streams by using the attribute slice start code, and the attribute slice headers are in one-to-one correspondence with the attribute data bit-streams; or the attribute data bit-streams are located in the loop statement, the loop statement traverses the attribute data bit-streams by using an attribute data start code, and the attribute header corresponds to one or more attribute data bit-streams.

Specific details of modules and units in the foregoing point cloud processing apparatus 300 have been described in detail in the embodiments of the foregoing point cloud processing method applied to the decoding device, and details are not described herein again.

According to the method described in the foregoing embodiment, an embodiment of the present disclosure further provides a point cloud processing apparatus, configured to perform operations in the foregoing point cloud processing method applied to an encoding device. FIG. 9 is a schematic structural diagram of another point cloud data processing apparatus according to an embodiment of the present disclosure. The point cloud processing apparatus 400 is applied to an encoding device (such as a content producing device), and includes a second obtaining module 401 and an encoding and compressing module 402.

The second obtaining module 401 is configured to obtain point cloud data; and

the encoding and compressing module 402 is configured to encode and compress the point cloud data, to obtain a point cloud bit-stream, the point cloud bit-stream including a plurality of point cloud frames, decoding indication information of the point cloud bit-stream including at least one of a first indication parameter or a second indication parameter, the first indication parameter being set in sequence-level parameter information of a point cloud sequence, the second indication parameter being set in frame-level or slice-level parameter information of the point cloud sequence, the first indication parameter providing sequence-level decoding indication, the second indication parameter providing frame-level or slice-level decoding indication, and the point cloud bit-stream being decoded according to the first indication parameter or the second indication parameter.

Specific details of modules and units in the foregoing point cloud processing apparatus 400 have been described in detail in the embodiments of the foregoing point cloud processing method applied to the encoding device, and details are not described herein again.

In some embodiments, the point cloud processing apparatus in this embodiment of the present disclosure may be an electronic device, or may be a component, such as an integrated circuit or a chip, in the electronic device. The electronic device may be a terminal or devices other than the terminal. For example, the electronic device may be a mobile phone, a tablet computer, a notebook computer, a palmtop computer, an in-vehicle electronic device, a mobile Internet device (MID), an augmented reality (AR)/virtual reality (VR) device, a robot, a wearable device, an ultra-mobile personal computer (UMPC), a netbook, or a personal digital assistant (PDA), or the like, or may be a server, a network attached storage (DNS), a personal computer (PC), a television (TV), a teller machine, a self-service machine, or the like. This is not specifically limited in this embodiment of the present disclosure.

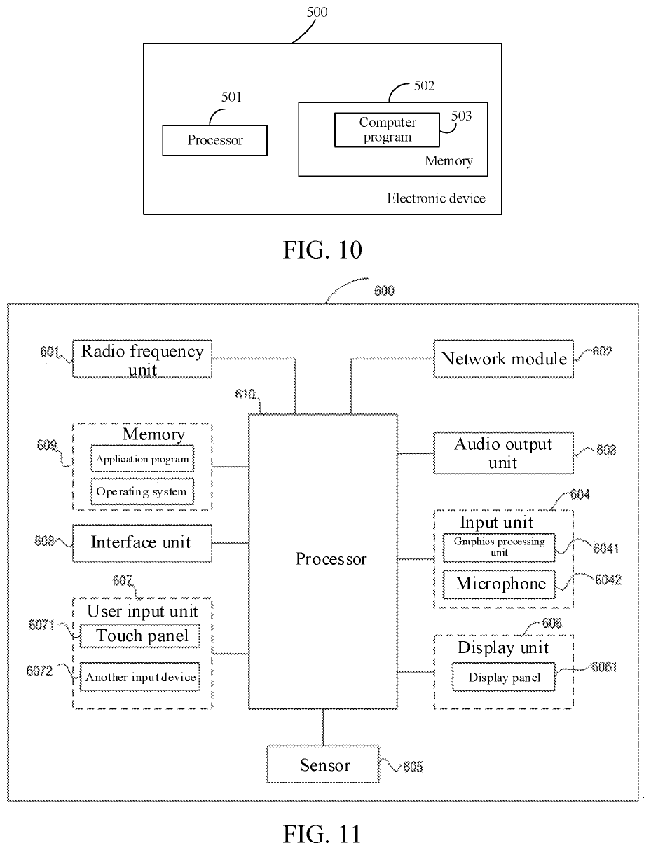

In some embodiments, as shown in FIG. 10, an embodiment of the present disclosure further provides an electronic device 500, including a processor 501, a memory 502, and a computer program that is stored in the memory 502 and can be run on the processor 501, the program, when executed by the processor 501, implementing processes of the foregoing point cloud processing method embodiments to achieve a same technical effect. To avoid repetition, details are not described herein again.

The electronic device in this embodiment of the present disclosure includes the foregoing mobile electronic device and non-mobile electronic device.

FIG. 11 is a schematic diagram of a hardware structure of an electronic device according to an embodiment of the present disclosure.

The electronic device 600 includes, but is not limited to, components such as a radio frequency unit 601, a network module 602, an audio output unit 603, an input unit 604, a sensor 605, a display unit 606, a user input unit 607, an interface unit 608, a memory 609, and a processor 610.

The electronic device 600 may further include a power supply (such as a battery) supplying power to the components, the power supply may be logically connected to the processor 610 by using a power management system, thereby implementing functions such as charging, discharging, and power consumption management by using the power management system. The structure of the electronic device shown in FIG. 11 does not constitute a limit to the electronic device. The electronic device may include more or fewer components than those shown in the figure, may be formed by combining some components, or may have different component deployment. Details are not described again herein.

In this embodiment of the present disclosure, the input unit 604 may include a graphics processing unit (GPU) 6041 and a microphone 6042. The graphics processing unit 6041 processes image data of a static picture or a video that is obtained by an image capturing apparatus (such as a camera) in a video capture mode or an image capture mode. The display unit 606 may include a display panel 6061, which may employ a liquid crystal display and an organic light-emitting diode to configure the display panel 6061. The user input unit 607 includes at least one of a touch panel 6071 and another input device 6072. The touch panel 6071 is further referred to as a touchscreen. The touch panel 6071 may include two portions, namely, a touch detection apparatus and a touch controller. The another input device 6072 may include, but is not limited to, a physical keyboard, a functional key (such as a volume control key or a switch key), a track ball, a mouse, and a joystick. This is not repeated herein.

The memory 609 may be configured to store software programs and data. The memory 609 may mainly include a first storage area for storing a program or instructions and a second storage area for storing data, where the first storage area may store an operating system, an application required by at least one function (such as a sound playback function and an image display function), and the like. Furthermore, the memory 609 may include a volatile memory or a non-volatile memory; or the memory 609 may include both the volatile memory and the non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM), a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct rambus RAM (DR RAM). The memory 609 described in the embodiments of the present disclosure includes, but is not limited to any suitable type of memories.

The processor 610 may include one or more processing units; and the processor 610 integrates an application processor and a modem. The application processor mainly processes operations involving an operating system, a user interface, an application, and the like. The modem mainly processes a wireless communication signal, such as a baseband processor. The foregoing modem may not be integrated into the processor 610.

An embodiment of the present disclosure further provides a non-transient computer-readable storage medium having a computer program stored therein, the computer program, when executed by a processor, implementing the processes of the aforementioned point cloud processing method embodiments to achieve a same technical effect. To avoid repetition, details are not described again herein.

The processor is the processor in the electronic device in the foregoing embodiment. A readable storage medium includes a computer-readable storage medium, such as a computer read-only memory (ROM), a random access memory (RAM), a magnetic disk, or an optical disc.

An embodiment of the present disclosure further provides a computer program product, including a computer program, the computer program, when executed by a processor, implementing the foregoing point cloud processing method.

The processor is the processor in the electronic device in the foregoing embodiment. A readable storage medium includes a computer-readable storage medium, such as a computer read-only memory (ROM), a random access memory (RAM), a magnetic disk, or an optical disc.

Although the embodiments of the present disclosure have been shown and described, a person of ordinary skill in the art may understand that various changes, modifications, replacements, and variations may be made to these embodiments without departing from the principle and spirit of the present disclosure. The scope of the present disclosure is defined by the claims and their equivalents.

What is claimed is:

1. A point cloud processing method, comprising:
obtaining decoding indication information of a point cloud bit-stream, the decoding indication information comprising at least one of a first indication parameter or a second indication parameter, the first indication parameter being set in sequence-level parameter information of a point cloud sequence and providing sequence-level decoding indication, the second indication parameter being set in frame-level or slice-level parameter information of the point cloud sequence and providing frame-level or slice-level decoding indication; and
decoding the point cloud bit-stream according to the first indication parameter or the second indication parameter.

2. The method according to claim 1, wherein the sequence-level parameter information comprises a sequence header, the sequence header comprises a third indication parameter, and the third indication parameter indicates whether the decoding of the point cloud bit-stream is performed according to the first indication parameter or the second indication parameter; and
the decoding the point cloud bit-stream according to the first indication parameter or the second indication parameter comprises:
decoding a point cloud frame of the point cloud sequence according to the first indication parameter in response to a value of the third indication parameter being a first preset value; and
decoding the point cloud frame according to the second indication parameter of each point cloud frame in response to the value of the third indication parameter being a second preset value, the first preset value and the second preset value being different.

3. The method according to claim 1, wherein the first indication parameter and the second indication parameter each comprises at least one of a bounding box origin coordinate field, a bounding box size field, or a quantization parameter field.

4. The method according to claim 1, wherein the first indication parameter is determined according to the second indication parameter of a point cloud frame of the point cloud sequence.

5. The method according to claim 1, wherein the decoding indication information further comprises a fourth indication parameter, the fourth indication parameter indicates a grouping manner of each point cloud frames of the point cloud sequence, and the method further comprises:
determining a decoding manner of a point cloud frame according to the fourth indication parameter, the decoding manner comprising at least one of a direct prediction method or a prediction and transform method.

6. The method according to claim 5, wherein the grouping manner comprises one of:
dividing points in one group into a plurality of sub-groups according to a preset grouping threshold, and performing grouping for a latter sub-group after a number of points of a preceding sub-group reaches the preset grouping threshold;
in response to that the current point for grouping is a duplicate point, supplementing a current sub-group with a current point until the number of the points of the current sub-group reaches the preset grouping threshold, and dividing each of the remaining duplicate points into a separate sub-group, wherein the duplicate point is a point that is the same as a point in the group to which the point belongs or as a point among previous N points, and N is a positive integer;
in response to that the current point for grouping is the duplicate point, supplementing the current sub-group with the current point until the number of the points in the current sub-group reaches the preset grouping threshold, and stopping continuous grouping for remaining duplicate points;
determining, in response to that the current point for grouping is the duplicate point, that grouping for the current sub-group is completed, and continuing grouping for the remaining points according to the preset grouping threshold;
determining, in response to that the current point for grouping is the duplicate point, that grouping for the current sub-group is completed, and dividing each of the remaining duplicate points into a separate sub-group; and
determining, in response to that the current point for grouping is the duplicate point, that grouping for the current sub-group is completed, and stopping continuous grouping for the remaining duplicate points.

7. The method according to claim 5, wherein the determining a decoding manner of a point cloud frame according to the fourth indication parameter comprises:
determining the decoding manner of a current sub-group according to the fourth indication parameter in response to that the current sub-group comprises a duplicate point.

8. The method according to claim 5, further comprising:
determining whether dynamic grouping is performed according to a related parameter of a quantization parameter of the point cloud frame or a maximum number of points in a sub-group;
adjusting a current right-shift number according to an average value of the quantities of points in previous M consecutive sub-groups if the dynamic grouping is performed, M being a positive integer;
determining a target number of bits of a code corresponding to the points for grouping according to the adjusted current right-shift number; and
performing grouping again according to values in the target number of bits.

9. The method according to claim 1, further comprising:
determining that a predicted value of an attribute type of a current point to be decoded is a reconstructed value of the attribute type of a preceding point of the current point in response to that the current point is a duplicate point, and determining that a current residual value of the attribute type of the current point is a non-negative number or a non-positive number.

10. The method according to claim 9, wherein the attribute type comprises a color attribute, and the determining that a predicted value of a attribute type of a current point is a reconstructed value of the attribute type of a preceding point of the current point comprises:
determining that a predicted value of a K^{th} component of the color attribute of the current point is a reconstructed value of the K^{th} component of the preceding point of the current point in response to that the current point is the duplicate point, and determining that the K^{th} component of the current residual value of the color attribute of the current point is a non-negative number or a non-positive number, K being an integer of 1 to 3; or
determining that a predicted value of each component of the color attribute of the current point is a reconstructed value of each component of the preceding point of the current point in response to that the current point is the duplicate point, and determining that each component of the current residual value of the color attribute of the current point is a non-negative number or a non-positive number.

11. The method according to claim 1, further comprising:
determining that a predicted value of a reflectivity attribute of a current point to be decoded is a reconstructed value of a reflectivity attribute of a preceding point of the current point in response to that the current point is a duplicate point, and determining that a sign bit of a current residual value of the reflectivity attribute of the current point is a non-negative number or a non-positive number.

12. The method according to claim 1, wherein the sequence-level parameter information comprises a sequence header, the decoding indication information further comprises a fifth indication parameter, the fifth indication parameter indicates a decoding frame rate, the fifth indication parameter is set in the sequence header, a value of the fifth indication parameter comprises one of a plurality of preset values, and the plurality of preset values corresponds to different decoding frame rates.

13. The method according to claim 1, wherein the decoding indication information further comprises an attribute header set in the point cloud frame, the attribute header comprises an attribute quantization parameter field, the attribute quantization parameter field is configured for controlling an attribute quantization parameter of the point cloud, and the attribute quantization parameter providing attribute decoding indication for attribute quantization of the point cloud frame.

14. The method according to claim 13, wherein the attribute header comprises a plurality of attribute types, each attribute type has an attribute quantization parameter field, the attribute quantization parameter field under a target attribute type is configured for controlling the attribute quantization parameter of the point cloud under the target attribute type, the attribute quantization parameter under the target attribute type provides attribute decoding indication for attribute quantization of the point cloud frame under the target attribute type, and the target attribute type is one of the plurality of attribute types.

15. The method according to claim 1, wherein the point cloud sequence comprises a point cloud frame, the point cloud frame comprises a point cloud slice, the point cloud slice comprises an attribute slice header, and the decoding indication information further comprises an attribute quantization parameter field set in the attribute slice header.

16. The method according to claim 13, wherein in response to that the attribute type of the attribute quantization parameter field is a reflectivity attribute, the attribute quantization parameter field comprises at least one of a reflectivity attribute quantization parameter or a reflectivity attribute quantization parameter offset; and in response to that the attribute type of the attribute quantization parameter field is a color attribute, the attribute quantization parameter field comprises one of: a color attribute quantization parameter and an attribute quantization parameter offset of each color component.

17. The method according to claim 1, wherein the decoding indication information comprises a loop statement set in the point cloud sequence, the point cloud sequence comprises the point cloud frame, the point cloud frame comprises the point cloud slice, the point cloud slice comprises the attribute slice, the attribute slice is located in the loop statement, and the loop statement traverses the attribute slices by using an attribute slice start code.

18. The method according to claim 1, wherein the point cloud sequence comprises the point cloud frame, the point cloud frame comprises the point cloud slice, the point cloud slice comprises the attribute slice, the decoding indication information comprises a loop statement set in the attribute slice, and the attribute slice comprises an attribute slice header and an attribute data bit-stream;
the attribute slice header and the attribute data bit-stream are both located in the loop statement, the loop statement traverses each of the attribute slice headers and each of the attribute data bit-streams by using the attribute slice start code, and the attribute slice headers are in one-to-one correspondence with the attribute data bit-streams; or
the attribute data bit-streams are located in the loop statement, the loop statement traverses each of the attribute data bit-streams by using an attribute data start code, and the attribute slice header corresponds to one or more attribute data bit-streams.

19. A point cloud processing method, applied to an encoding device, the method comprising:
obtaining point cloud data; and
encoding and compressing the point cloud data, to obtain a point cloud bit-stream, decoding indication information of the point cloud bit-stream comprising at least one of a first indication parameter or a second indication parameter, the first indication parameter being set in sequence-level parameter information of a point cloud sequence and providing sequence-level decoding indication, the second indication parameter being set in frame-level or slice-level parameter information of the point cloud sequence and providing frame-level or slice-level decoding indication, and the point cloud bit-stream being decoded according to the first indication parameter or the second indication parameter.

20. A non-transitory computer-readable storage medium, having a computer program stored therein, the computer program, when executed by at least one processor, causing the at least one processor to implement:
obtaining decoding indication information of a point cloud bit-stream, the decoding indication information comprising at least one of a first indication parameter or a second indication parameter, the first indication parameter being set in sequence-level parameter information of a point cloud sequence and providing sequence-level decoding indication, the second indication parameter being set in frame-level or slice-level parameter information of the point cloud sequence and providing frame-level or slice-level decoding indication; and
decoding the point cloud bit-stream according to the first indication parameter or the second indication parameter.
